(19) United States
(12) Patent Application Publication
(10) Pub. No.: US 2003/0046639 A1
(43) Pub. Date: Mar. 6, 2003

(54) Method and systems for facilitating creation, presentation, exchange, and management of documents to facilitate business transactions

(75) Inventors: Hung Ka Fai, Wanchai (HK); Lam Wing Bavflynn, Wanchai (HK); Tai Jin Yen, Wanchai (HK)

Correspondence Address: Dinh & Associates, 2506 Ash Street, Palo Alto, CA, 94306, US

(73) Assignee: Core IPR Limited, Wanchai (HK)

(21) Appl. No.: 10/143,548

(22) Filed: May 9, 2002

Related U.S. Application Data
(60) Provisional application No. 60/290,079, filed on May 9, 2001.

(51) Int. Cl. G06F 15/00

(52) U.S. Cl. 715/513

(57) ABSTRACT

Techniques for integrating software systems, application tools, and business modules into a unified platform and open framework for building, deploying, and maintaining business applications of different types and varying nature in a heterogeneous computing environment. This is achieved by configuring the semantics of business entities, the presentation of structured and semi-structured information, the processing rules and logics among business modules, and the relationships of the participating users and organizations with other business entities. Integration of the software systems, application tools and business modules is achieved through integration of the key elements, which are business semantics, presentation logics, business rules, user entities and system models.

### CROSS-REFERENCES TO RELATED APPLICATIONS

This application claims the benefit of provisional U.S. Application Serial No. 60/290,079, entitled “Method and System for Facilitating Creation, Presentation, Exchange, and Management of Documents to Facilitate Business Transactions,” filed May 9, 2001, which is incorporated herein by reference in its entirety for all purposes.

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

The present invention generally relates to computer processing, and more particularly to techniques to facilitate the creation, presentation, exchange, and management of documents for business transactions.

Over the last decade, the growth of the Internet has pushed businesses and industries worldwide into a digital era where the key to remaining competitive is putting the customer front and center in one's business. For many business enterprises, a major move toward this end involves integrating internal business applications and building up new electronic business application systems for use in a communication network (e.g., the Internet) that supports interaction with other business enterprises or customers. However, most of the information technology (IT) professionals are still struggling with the process to migrate their business applications over to networked systems.

The migration toward networked systems has proven to be challenging for a number of reasons. Each business application typically covers a set of business transactions and activities and operates based on its own set of business “semantics” and presentation logics. Conventionally, business applications are specifically implemented as customized systems. Business semantics and presentation logics typically differ from system to system and from application to application. Data formats and message structures typically also vary, sometimes radically, between systems from different vendors and sometimes even within the same vendor's different systems. This makes seamless inter-system data sharing, or structured workflow, between business enterprises improbable.

Although electronic data interchange (EDI) technologies are available and allow enterprises to exchange data, its implementation is nevertheless too expensive for many small and medium-sized enterprises (SMEs). Thus, EDI is typically only available to a limited number of business enterprises and for a limited number of tasks that can appear too narrow in scope in an e-business environment.

Conventionally, developing and deploying “rich” business applications over a communications network (e.g., the Internet) is a complex undertaking. Even though the industry has made great advances with protocols, development tools, and server software, much of the effort is spent developing, deploying, and maintaining applications with existing tools, protocols, and technologies. The list of difficulties and challenges in developing and deploying networked business application systems is lengthy.

Accordingly, a business enterprise conventionally spends months to integrate its existing applications, develop new e-business applications, and deploy these onto a communications network (e.g. the Internet). With conventional technologies, the starting point of a common design approach to developing an e-business application is to first come up with a set of business process models that describe various business activities and transactions. An application system is then developed from the models. Examples of business activities to be modeled may include processing purchase orders, insurance claims, and so on. Once an actual software application is derived from the business models and processes, in conjunction with other software systems and a team of humans, a defined set of business functions and processes could then be provided. With this design approach, the e-business application typically cannot be easily modified, customized, and deployed when new business requirements arise.

Although current technologies support modeling, developing, and deploying e-business application systems, the need for quickly and easily adapting the logics of the business processes without redeveloping the application a second time from the ground up has not yet been addressed. Conventional technologies could not easily separate presentation logics of the application systems from the business processes and rules. To some extent, the systems can be improved to incorporate new functionalities by changing parts of the system or some designated components of the system. However, the amount of time required to achieve such changes could not be reliably estimated and predicted in advance. In many cases, the actual amount of time required to accommodate such business requirement changes is comparable to the time required to redevelop the application a second time from scratch. Because of that, business enterprises are restricted on how frequent changes could be incorporated into existing applications. This, however, is very undesirable as businesses are continually faced with changes.

Furthermore, conventional technologies are typically limited to abstracting object models from existing software implementations, and are not generalized in nature. E-business applications developed are generally “tailor-made” to suit a set of specific business needs, and that specific implementation typically cannot be ported and applied easily to other business environments. As an example of this shortcoming, an e-business application developed to handle purchase order processing typically cannot be thereafter re-used to handle insurance claim processing without significant changes. Major efforts are typically needed to incorporate new functionalities and to customize altered business rules.

Thus, techniques to facilitate the creation, presentation, exchange, and management of documents for business transactions are highly desirable.

### SUMMARY

Aspects of the invention provide a framework in which end-user software applications can be configured and deployed in a minimal timeframe and by people with minimal software development skills. The emphasis is on the configuration and deployment of the applications, instead of development of the applications.

Certain aspects of the invention result from the observation that most existing end-user software applications involve a certain amount of form filling (i.e. getting input from the user) and processing using some coded computations and validations, storage of the resulting information in a tailor-made format, rendering the information either as an individual piece or as a summary of multiple pieces of information, and controlling the access rights and relationships among participating entities. The differences of end-user software applications are mostly in the specific structure of the information being processed and the set of validations and computations of these pieces of structured information.

By observing that most of the above processing is common among all types of applications, it is feasible to provide intuitive interfaces for users with minimal technical skills to specify most, if not all, of the above ingredients of a software application. The development resources concentrate on the remaining delicate and proprietary processing logics and integration with other systems. By doing so, the tasks that require sophisticated skills are greatly reduced, resulting in a much smaller chance to produce defects.

As such, aspects of the invention provide the interfaces for configuring the semantics of the structured and semi-structured information, the presentation of individual pieces of such information, the presentation of summaries of multiple pieces of such information, the processing logics of individual pieces of information and across multiple pieces of related information, the access rights and relationships among the participating entities.

Various other aspects, embodiments, and features of the invention are provided, as described in further detail below.

The foregoing, together with other aspects of this invention, will become more apparent when referring to the following specification, claims, and accompanying drawings.

### BRIEF DESCRIPTION OF THE DRAWINGS

FIG. 1 is a diagram that illustrates a set of business transactions for a particular business process involving a number of business enterprises;

FIG. 2 is an overall diagram illustrating an iDEX system and its interconnection with a networked system and a number of small and medium-sized enterprises (SMEs);

FIGS. 3A through 3C are diagrams of an architectural view for three embodiments of the iDEX system;

FIG. 4 is a block diagram that illustrates the basic structure of a framework supported by the iDEX system;

FIG. 5 is a diagram illustrating how a piece of structured information can be rendered in a comprehensible format;

FIG. 6 is a diagram illustrating an implementation for configuring a delivery and response hierarchy;

FIG. 7 is simple diagram illustrating how a new piece of information (e.g., a particular document) can be related to one or more existing pieces of information (e.g., another document) by preconfigured criteria defined by an administrator;

FIG. 8 is a diagram illustrating a data inheritance relationship;

FIG. 9A is a block diagram of a multi-tier architecture used for the iDEX system;

FIG. 9B is a diagram that shows the interaction between different types of clients and the EJB container to support interaction with the users;

FIGS. 10A and 10B are diagrams of a model-view-controller (MVC) architecture and an implementation of the MVC architecture in the iDEX system, respectively;

FIG. 11 is a diagram of a message-oriented system queue for the iDEX system;

FIG. 12A is a diagram of an event driven finite-state-machine architecture for the iDEX system;

FIG. 12B is a diagram illustrating a producer architecture for the iDEX system;

FIG. 13 is a diagram illustrating a server-side caching architecture used for the iDEX system;

FIG. 14 is a diagram illustrating an event-passing model used for the iDEX system;

FIG. 15 is a diagram illustrating a request handler design model for the iDEX system;

FIG. 16 is a diagram illustrating a security model for the iDEX system; and

FIG. 17 is a block diagram of an embodiment of a computer system that may be used to implement the iDEX server in FIG. 2.

### DESCRIPTION OF THE SPECIFIC EMBODIMENTS

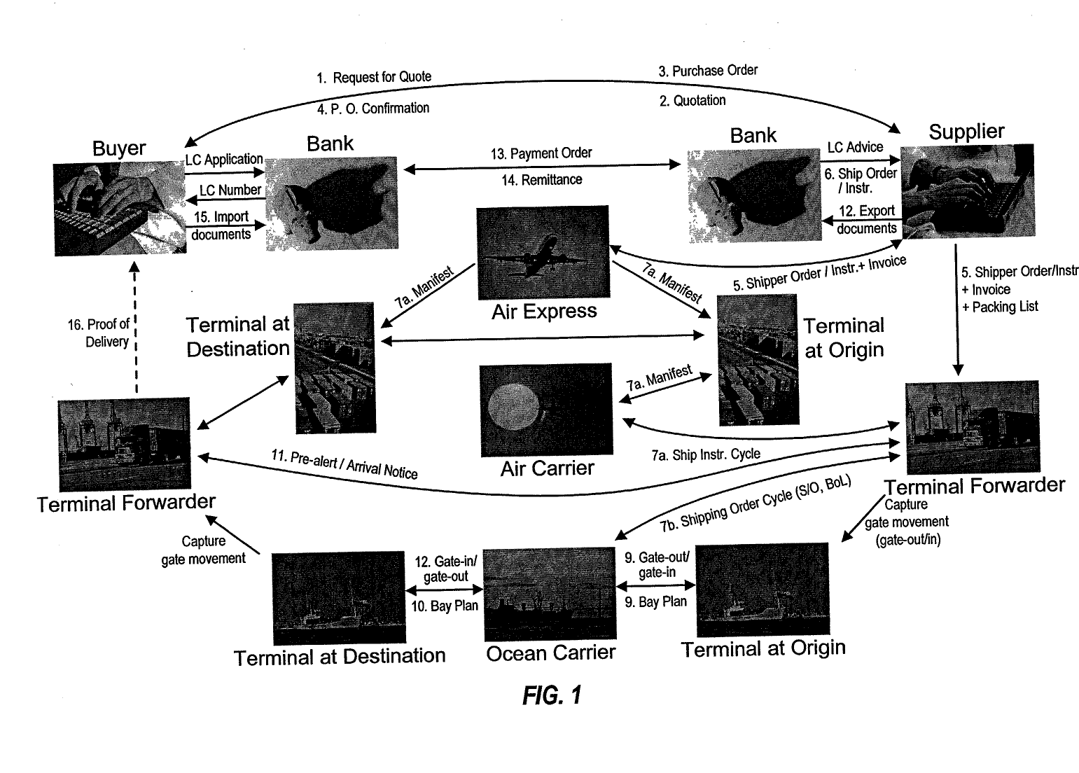

FIG. 1 is a diagram that illustrates a set of business transactions for a particular business process involving a number of business enterprises. A business process may entail, e.g., the purchase of a particular equipment and may require a number of transactions to be performed to complete the process, e.g., starting with a request for quotation and concluding with a confirmation of the actual delivery of the equipment. The transactions are typically performed in a particular order defined by the business process, and the completion of one transaction typically triggers the initiation of the next transaction. Each transaction is performed between two or more business enterprises and may be associated with and represented by one or more documents. Each transaction may further require a set of actions (e.g., reviews, approvals, and so on) by each of the enterprises involved in the transaction.

As can be seen in FIG. 1, the amount of documents that may need to be generated and exchanged can be enormous. Moreover, a large number of business enterprises may be involved in any given business process. Each entity (e.g., a shipper) may also need to interact with a number of other enterprises (e.g., its “customers”) on a number of business transactions that may be based on various different business processes. Consequently, the task of supporting and managing the documents for these various enterprises can be very challenging.

Various aspects of the invention provide techniques to facilitate the creation, presentation, exchange, and management of documents to efficiently facilitate business transactions. As used herein, a “document” is a collection of data that may be in any format or form. In one aspect, an Internet data exchange (iDEX) system is described having the capability to efficiently facilitate the creation, presentation, exchange, and management of documents. Other aspects are described in further detail below.

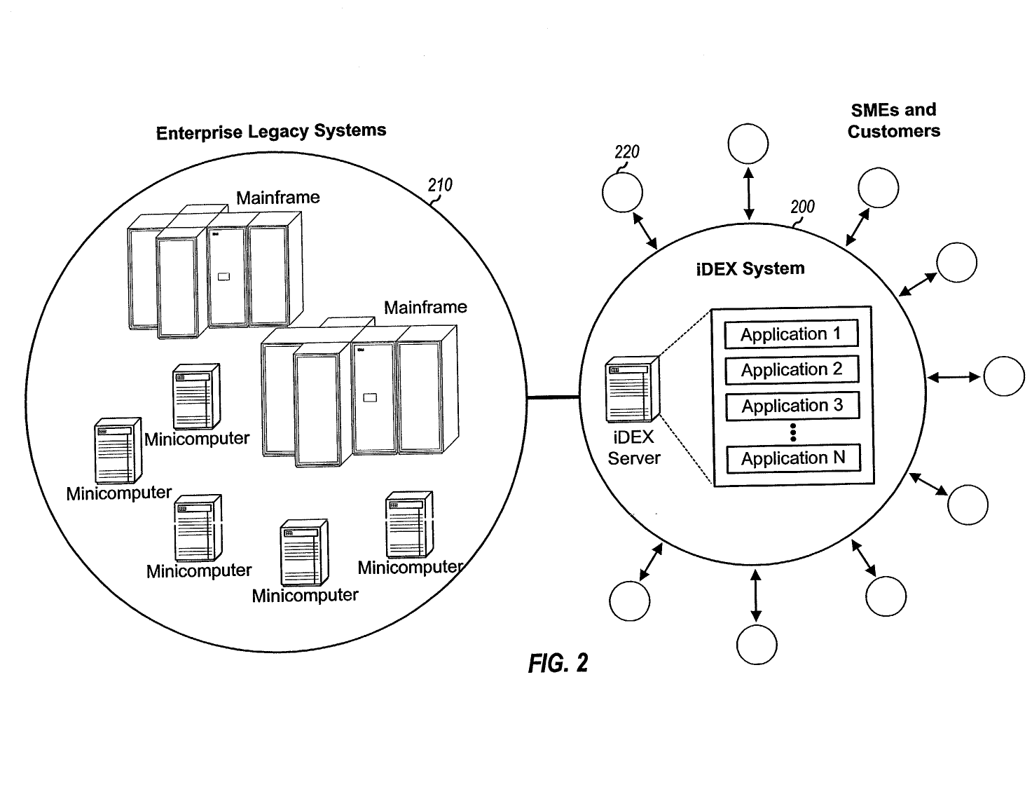

FIG. 2 is an overall diagram illustrating the iDEX system 200 and its interconnection with a networked system 210 and a number of small and medium-sized enterprises (SMEs) 220. Various other legacy systems are conventionally available to facilitate the creation and management of documents. However, these legacy systems tend to be custom designed to suit the specific needs of (typically large) business enterprises with the resources to afford such systems. A long period of time (e.g., months, or even years) is typically required to model the business processes of an enterprise and to implement a custom application system specifically suited for the business processes of that enterprise. Besides requirement extensive effort to develop, this custom system may not be easily adapted to accommodate changes in business requirements and/or to support new business processes not originally considered.

The iDEX system may be configured to support a number of applications for a number of business enterprises in support of their various business processes. In an aspect, the iDEX system provides an “infrastructure” of tools and basic building blocks that may be used to support new business enterprises and their processes. This allows a new application to be built in a much shorter period of time (e.g., days) than that conventionally required to develop a customized application system. Moreover, changes to business requirements may be easily accommodated via the iDEX system using the provided tools and blocks. The iDEX system may be operated by an application service provider (ASP) and may be made available and accessible to SMEs, which would not otherwise have the resources to implement their own customized application systems. The iDEX system can interact and transact with legacy application systems to provide a high level of interconnectivity with other business enterprises.

1. iDEX System

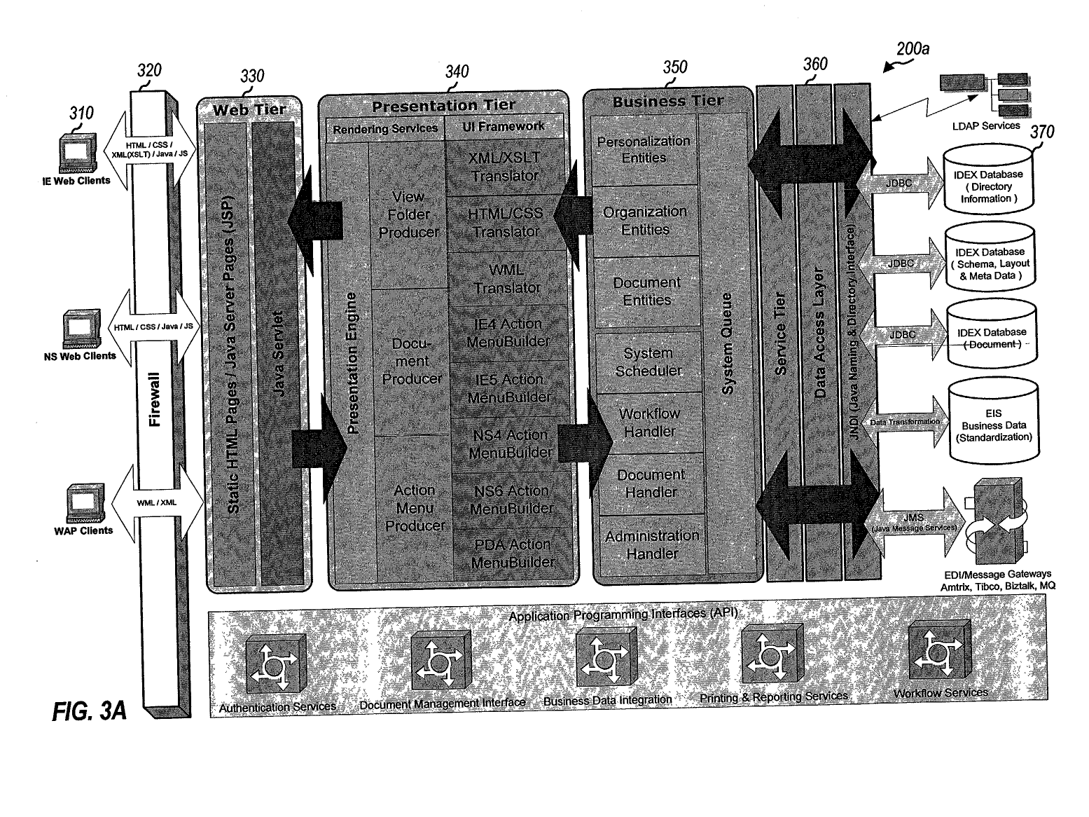

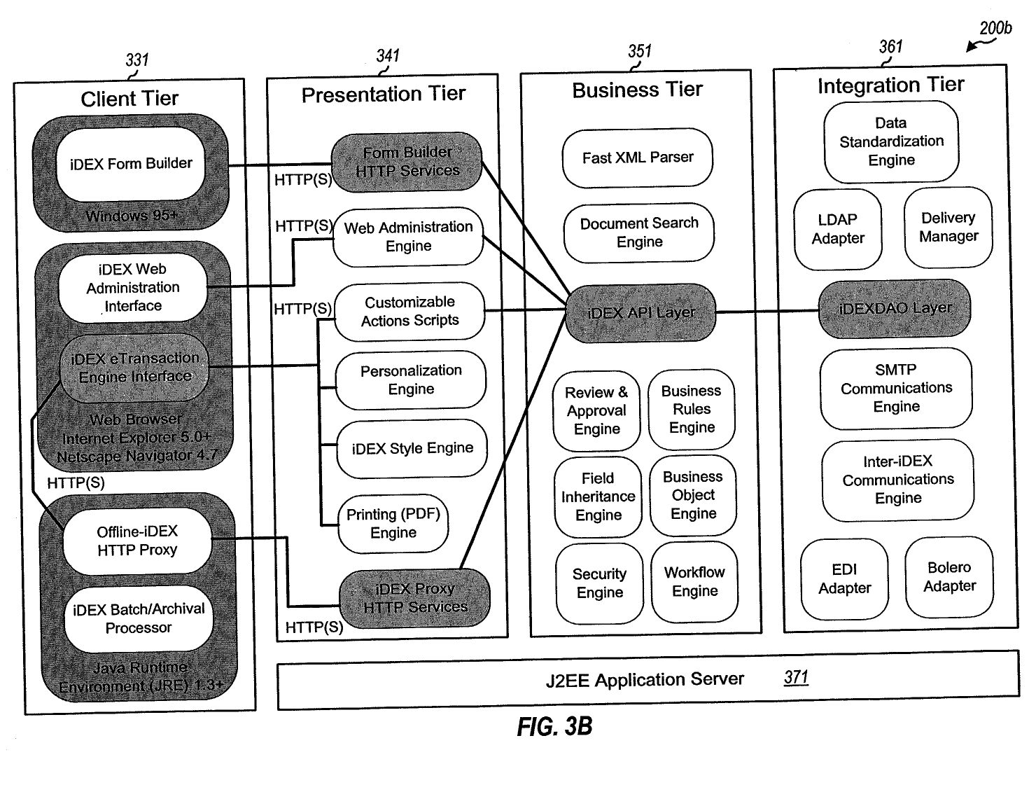

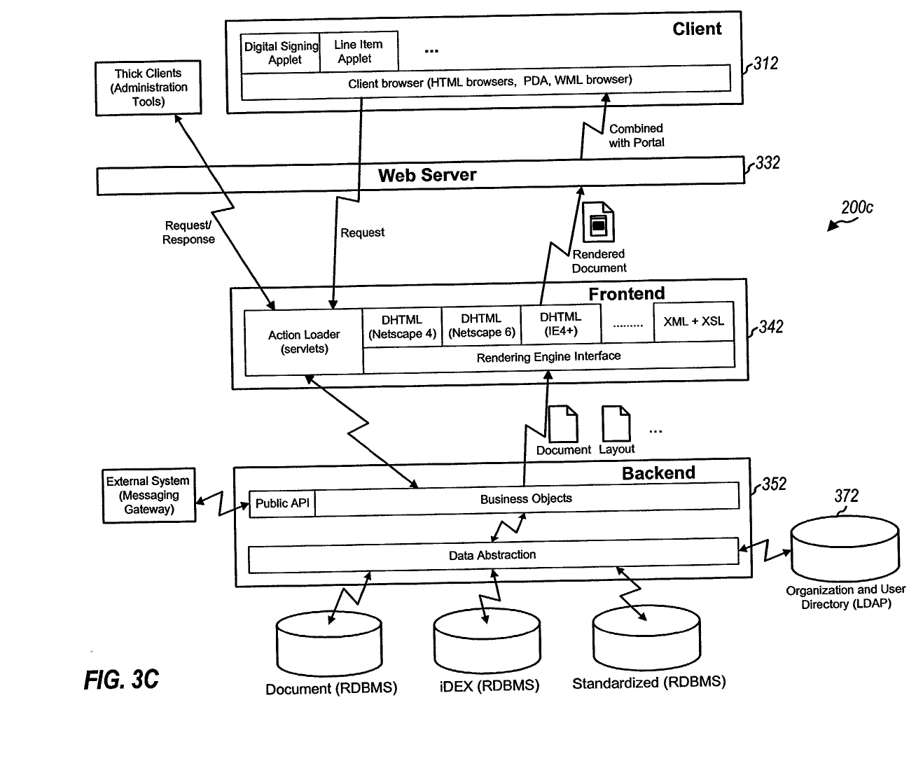

FIG. 3A is a diagram of an architectural view for a first embodiment of an iDEX system 200a. Various clients 310 interfaces with the iDEX system via a firewall 320 that provides security for the iDEX system.

In the specific embodiment shown in FIG. 3A, the iDEX system comprises multiple tiers/layers including a Web tier 330, a presentation tier 340, a business tier 350, and a database interface tier 360. The Web tier provides the interface between the iDEX system and the clients. The presentation tier supports the creation, presentation, exchange, and management of documents. The business tier supports the management of organizations, documents, and other entities, and further controls the various processes of the iDEX system. The database interface tier provides interface with various databases 370.

As shown in FIG. 3A, each of the presentation and business tiers includes a number of modules that provide the desired functionality. With the layered architecture, additional functionality and capability may be easily implemented on the iDEX system, and modification to existing modules may be easily performed. Each of the tiers is described in further detail below.

FIG. 3B is a diagram of an architectural view for a second embodiment of an iDEX system 200b. In this embodiment, the iDEX system comprises multiple tiers including a client tier 331, a presentation tier 341, a business tier 351, and an integration tier 361. The client tier provides the interface between the iDEX system and the clients. The client tier may also be designed to support various client platforms such as, for example, Windows™, Web browsers, and Java. The presentation tier supports the creation, presentation, exchange, and management of documents. The business tier supports the management of organizations, documents, and other entities, and further controls the various processes of the iDEX system. The integration tier provides interface with various other systems (e.g., legacy systems) and standard interfaces.

As shown in FIG. 3B, each of the presentation and business tiers includes a number of modules that provide the desired functionality. Additional and/or different modules may also be implemented to provide additional and/or different functionality and capability.

FIG. 3C is a diagram of an architectural view of a third embodiment of an iDEX system 200c. In this embodiment, the iDEX system includes a Web server 332, a frontend 342, and a backend 352. The Web server provides the interface between the iDEX system and the clients 312, and approximately corresponds to the Web tier 330 in FIG. 3A. The frontend 342 supports the creation, presentation, exchange, and management of documents, and approximately corresponds to the presentation tier 340 in FIG. 3A. The backend 352 supports the management of organizations, documents, and other entities, controls the various processes of the iDEX system, and further interfaces with the databases. The backend 352 approximately corresponds to the business tier 350 and data interface tier 360 in FIG. 3A. Again, the various parts of the iDEX system in FIG. 3C are described in further detail below.

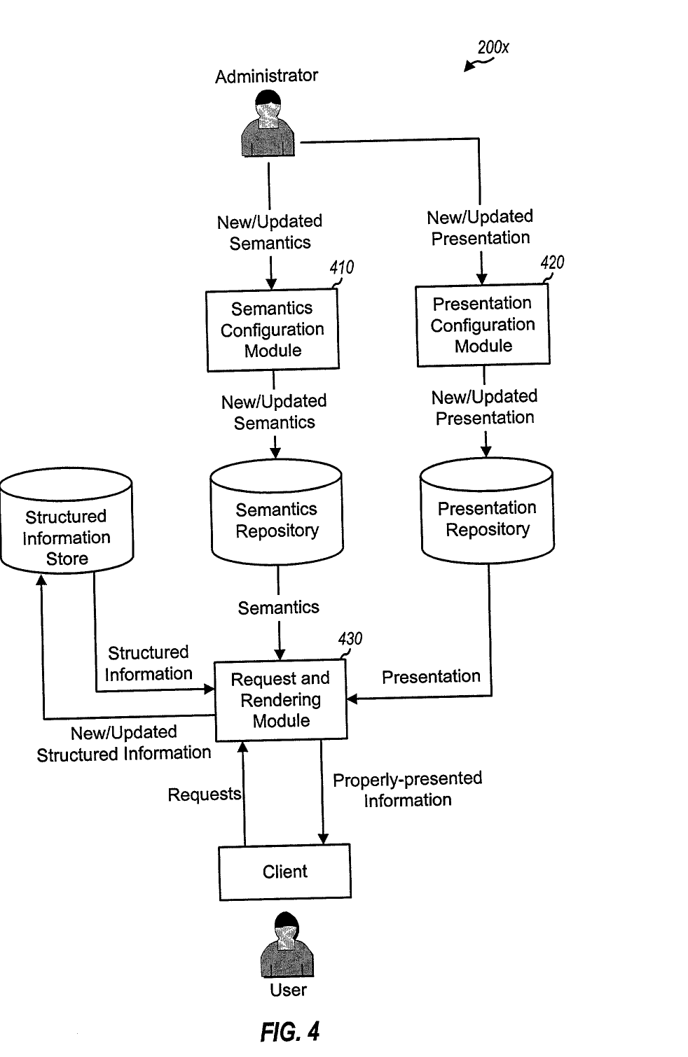

FIG. 4 is a block diagram that illustrates the basic structure of a framework supported by the iDEX system. FIG. 4 shows a logical view of the iDEX system. A semantics configuration module 410 supports the configuration of the structures of individual pieces of information. A typical structure includes fields and sections, and each section may include multiple fields. A field may include one or more values. An “enriched” implementation of module 410 can include configurations such as data types of the fields, validation specifications of the fields, and/or computations of the fields.

A presentation configuration module 420 supports the configuration of the presentations of individual pieces of information. For each individual piece of information, there can be one or more presentations for each different medium and for each mode of presentation. For example, a piece of information may be associated with a first presentation for one brand of Web browser, a second presentation for another brand of Web browser, a third presentation for a portable digital assistant, and so on. This same piece of information may further be associated with presentations for (1) inputting or editing information, (2) displaying information for reading, (3) displaying information for printing, and so on.

A request and rendering module 430 is responsible for interpreting and answering requests from a user. A request may be to provide an appropriate presentation for the user to (1) input new information, (2) pass a new or modified piece of information for validation according to defined semantics, (3) retrieve existing information using an appropriate presentation, and so on. A more detailed description of each of the functions performed by modules 410, 420, and 430 is provided below.

2. Organization Administration

In an embodiment, the iDEX system supports a hierarchical structure of users, with the structure having the following types of users:

System Administrator (SA)—a user who has the role of a system administrator.

Organization Administrator (OA)—a user who has the role of an organization administrator. A system administrator can perform any task that an organization administrator can perform.

Organization Unit Administrator (OUA)—a user who has the role of an organization unit administrator. An organization administrator can perform any task that an organization unit administrator can perform.

Group Administrator (GA)—a user who has the role of a group administrator. An organization administrator can perform any task that a group administrator can perform.

iDEX User—a user who has a registered account in the iDEX system. iDEX users are simply referred to as “users” herein.

The system administrator, organization administrator, organization unit administrator, and group administrator are collectively referred to as “administrators.” All administrators are also users of the iDEX system.

The iDEX system also supports a hierarchical organizational structure, with an organization being a root unit of the hierarchical structure. Each organization may include any number of organization units, each of which may further include any number of organization units under it. The hierarchical structure can continue with any number of layers, with each layer having any number of organization units. Each organization unit is identified by a unique name. An organization may be formed for a business enterprise or some other entity. A group is a logical arrangement to put together different organizations so as to act as a single entity for system administration and configuration settings.

System-Wide Administration. If a new organization desires to use the iDEX system, the system administrator registers the organization by entering all required information for the organization into the iDEX system and generating an organization ID for it. Once a new organization has been registered with the iDEX system, an administrator account ID and a password are created by the system administrator for the organization. This ID and password allow an organization administrator assigned to manage the organization to logon to the iDEX system and have all the rights and privileges to properly manage the organization. Some of these rights and privileges may include creating users, groups, code lists, access rights, and so on. The system administrator has the ability to categorize all organizations registered with the iDEX system based on various criteria (e.g., by industry, location, and so on).

Organizations (i.e., enterprises) external to the iDEX community may also be registered with the iDEX system by the system administrator to enable these organizations to exchange (i.e., send and receive) documents with users of the registered organizations. An external organization may be an organization on another iDEX community or may be another system (e.g., a legacy system) coupled to the iDEX system via any messaging gateway. An external organization may be registered in the iDEX system as a fictitious organization so that the document exchange mechanisms are unified with other registered organizations in the iDEX system. In an embodiment, the external organizations do not have any users, groups, or organization units. However, external organizations can have document schemas and layouts (e.g., as administered by the system administrator).

Each external organization is associated with an inbound queue and an outbound queue having names specified in the profiles of the organization. The inbound and outbound queues are used for routing documents to external systems. A document sent to an external organization is not stored in the iDEX system, but is instead routed to the outbound queue for further processing. The actual document delivery may be handled by programs external to the iDEX system. An external organization provides a uniform interface for document delivery.

An organization may be specified (by the system administrator) to be a public organization. A public organization shares its resources (including document schemas, views/folders, and information of the organization, groups, and users), which are readable by all other organizations in the system. However, the access right for a particular resource may be explicitly overridden.

Relationships may be established between organizations registered with the iDEX system. Various types of relationship are supported by the iDEX system including a document exchange relationship and a resource sharing relationship. Other types of relationship may also be implemented, and this is within the scope of the invention. The document exchange relationship allows one organization to exchange (i.e., send/receive) documents with another organization. The resource sharing relationship allows one organization to share its resources (e.g., document schema) with another organization. The above-described relationships may be unidirectional (i.e., one organization can access from another organization, but not vice versa) or bi-directional (i.e., two organizations can share and exchange).

A registered organization in the iDEX system may establish a one-to-one relationship with any other registered organization (via the system administrator). Thus, if four organizations desire to interact with each other, six relationships are established. For each relationship between two organizations, a document exchange relationship, a resource-sharing relationship, or both may be established. An organization may also declare itself as a public organization to allow other organizations to send request for building relationships.

A default organization profile may be provided with the iDEX system to simplify the creation of new organizations. The default organization profile may include commonly used fields and/or customized fields. Some or all of these fields may include default values. Similarly, a default user profile may be provided to simplify the creation of new users, and may also include commonly used fields and/or customized fields with possibly default values.

If a registered organization desires to discontinue use of the iDEX system, the system administrator deletes the organization and all of its related information from the iDEX system to disallow use by that organization. In an embodiment, if any information (e.g., a document schema) belonging to an organization to be deleted is used by another organization, then the organization is not deleted. In another embodiment, the information belonging to an organization to be deleted is transferred to the organization using the information so that the deletion can be safely performed.

A registered organization may also be deactivated to temporarily suspend its use of the iDEX system. The deactivation prevents any user belonging to the deactivated organization from logging on to the iDEX system, but all information for the organization is retained. A deactivated organization may be re-activated to allow its users to access the iDEX system.

Individual Organization Administration. For each registered organization, the profile of the organization and its groups is managed by one or more assigned organization administrators. An organization administrator can (1) read the information of the organization, (2) modify information in the organization profile (except for the organization name and ID, which are read-only to the organization administrator), (3) retrieve a sorted list of organization units and users under the organization in a hierarchical manner, (4) create any number of organization units under the organization, and so on.

Each organization unit is-administered by one or more organization unit administrators who can create, delete, and edit users and lower-level organization units. Each organization unit administrator can (1) read the information of the base organization unit (i.e., the root unit of all organization units under the organization unit administrator's administration), (2) modify the name and description of the base organization unit and any lower-level organization unit, (3) create a new organization unit under the base organization unit, (4) assign a user or group to be the organization unit administrator of a lower-level organization unit, (5) delete any lower-level organization unit (all organization units and users under the deleted organization unit are also deleted, but the organization unit administrator can confirm whether a child organization unit of the selected organization unit should also be deleted), (6) change the parent of a lower-level organization unit to any organization unit under the organization unit administrator's administration, (7) move a user that he/she administers to any organization unit under his/her administration, and so on.

An organization unit administrator can create a new user under any organization unit administered by the organization unit administrator. Each user is uniquely identified by combining the organization name and the hierarchy of organization units to which the user belongs. To create a new user under the iDEX system, the following information is provided: first name, last name, a unique user ID, and a password (which is encrypted when stored in the database and when displayed). Each user belongs to one and only one OU but may belong to one or more groups.

An organization unit administrator can (1) read the information in a user profile, (2) modify the information of the user (except for the user identifier, which is read-only), (3) retrieve a sorted list of the users under the organization unit being administered based on optional filtering criteria, (4) delete a user under an organization unit being administered by the organization unit administrator, (5) deactivate a user to disable the user from logging on to the system, (6) edit the information of a deactivated user, (7) activate a user who has been deactivated to enable the user to log on to the system, and so on.

When a user is deleted, (1) the user's information (e.g., preferences, group membership, private views and folders, saved search criteria, and entries in various access control lists (ACLs)) is also deleted, (2) the documents accessible by the user remain unchanged (although the user's entry in the corresponding ACLs is removed), (3) other functions such as delivering a document to the deactivated user remain valid. An organization administrator can enable/disable a user. A disabled user is not granted access rights to documents maintained by the iDEX system.

An organization unit administrator can create any number of groups under the base organization unit being administered and may assign one or more group administrators (group administrators) for each created group. Each group administrator can perform various functions for one or more groups under the group administrator's administration, similar to those performed by the organization unit administrator for the organization units under the organization unit administrator's administration. The group administrator may assign users to created groups and add/remove users under the group administrator's group and so on, but cannot create or delete users within other groups under the same organization.

The user accounts of the built-in system administrator and the built-in organization administrators cannot be deleted. The system administrator may delete the account of the built-in organization administrator only by deleting the entire organization.

Overhead Organization Administration. The organization administrator can select the default settings for the organization and further manages the organization profile. From the possible selections provided by the iDEX system, the organization administrator can select the default currency to be used in documents, the default language to be displayed, the default date/time format to be used, and so on, for all users in the organization being managed by the organization administrator. Each user may later override these defaults via personalization features described below. In addition to selecting the default settings, the organization administrator also maintains the information for the organization such as various contact addresses and information for companies with which the organization interacts and transacts.

3. Document Preparation

As used herein, a document refers to business data manifested in a particular representation supported by the iDEX system. A document is typically created via a Web browser, and a proper document layout is accessed and displayed to the user for the document creation. For this purpose, a rendering agent (e.g., module 430) is provided with the user preferences and the information of the client terminal so that the proper interface can be presented to the user.

A user can specify how the document is to be created from among a number of possible options. First, the user can create a new document based on an existing document schema, which is defined by the organization administrator. For this option, the iDEX system provides an empty document with its layout and other information for the user to enter the business data. Document schema and layout are described in further detail below. A list of document schemas available to the user may be provided, and the user then selects (the latest version of) one of the available schemas.

Second, the user may create a new document by providing information in a document that is related to a current document being viewed or edited. The list of related documents available for access by the user is defined, e.g., by the organization administrator. And third, the user may create a new document by providing information based on a template that may have been defined by the user or the organization administrator.

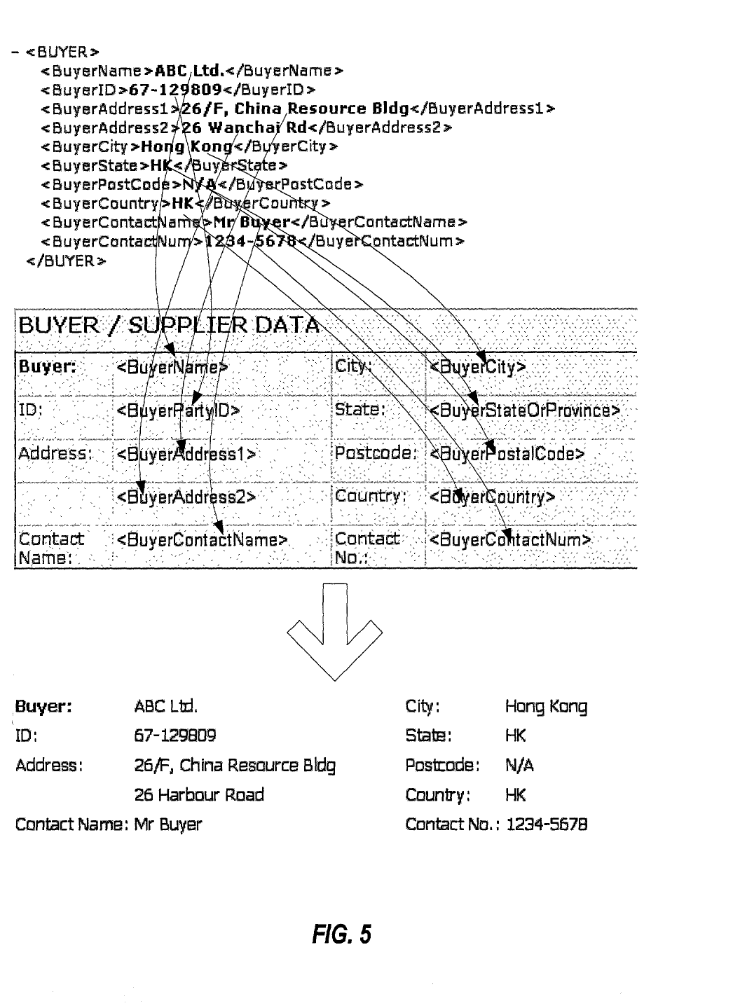

FIG. 5 is a diagram illustrating how a piece of structured information can be rendered in a comprehensible format. The structured information is in the form of a hierarchical structure, which in an embodiment is configured by an administrator. The presentation of the document may be in any rendering format such as Hypertext Markup Language (HTML), Rich Text Format (RTF), Portable Data Format (PDF), and so on. In an embodiment, the available rendering formats are configured by the administrator. When structured information is requested by a user, an appropriate presentation is selected according to the computer client that the user is using and the various preferences indicated by the user. The structured information is then filled in the presentation and rendered to the user.

Editing documents may be equated to activities such as preparing a purchase order, a quotation, or some other document made available in the user's parlance. The iDEX system allows the user to enter the business data for a document and thereafter validates and verifies the entered data. The type and nature of the data to be entered by the user and the validation rules may be defined by an administrator. The user enters data using the displayed document layout and facilities that may have been defined on the document schema, e.g., links to address book, look-ups to code lists, drop down lists, calendars, uploading of attachments, and so on. When the user requests to refer to, e.g., an address book or a code list, the system displays the requested information. In an embodiment, if a user edits a document and saves it, a new version number is automatically generated for the document by the iDEX system.

A prepared document may be saved in a “draft” mode or a “final” mode. In the draft mode, other users may be able to access and alter the document. Another user with access to the document can assign all or a subset of the user's access rights for this document. Access rights for the author cannot be removed by other users. Upon saving the document, validation is performed on the document based on validation rules for the document schema associated with the document, as determined by the administrator.

During document creation, a user may be allowed to attach other files (structured or unstructured) to the document before sending it to the recipient user. The attachment function may be enabled or disabled as needed to handle file attachments. The number of attachments is defined by the document schema.

Document Templates. A template is essentially a document with some default business data. For some business processes, users may be required to frequently create the same documents but with slightly different data. To facilitate the creation of these documents and to reduce time and errors during their creation, the iDEX system allows users the flexibility to generate templates via various methods. In one method, a user chooses a particular document schema from among a set of defined document schemas set up by an administrator and builds template using the selected document schema. In another method, the user can create a document and directly save it as a template. This option is made available for a document if the underlying document schema can be used to create a template. Directly saving a document as a template may be advantageous in cases when the same document needs to be sent to the same recipient on a regular basis (e.g., when a purchase order is placed with the same supplier for the same goods, on a monthly basis). The iDEX system provides user interfaces for creating, editing, saving, and deleting templates by users.

Document Manipulations. Various operations may be performed on or with documents maintained in the iDEX system. Operations on the documents include open and view, delete, cancel, copy, amend, and so on. Operations with the document include print, print preview, collaboration, approval process (approve/reject), and so on. These operations allow users to push documents through various stages, reuse the business data in the documents, and maintain hard copies of the documents, if and when necessary. For a given document, some of the operations may be applicable to only some document states and/or may be executed only by users with the proper access rights.

Collaboration is a feature that enables a document to be reviewed and updated by multiple users simultaneously. Also, collaboration can enable documents that have been received and documents that have been sent out to be linked together with a relationship definition configured by the system administrator. By using collaboration, the document state does not change nor do its version number and other attributes. Collaboration facilitates clarification and the establishment of some common understanding at every stage between two parties involved in the process, before moving on to the next stage of a business transaction. The approval process allows designated users to approve or reject a document.

4. Document Exchange

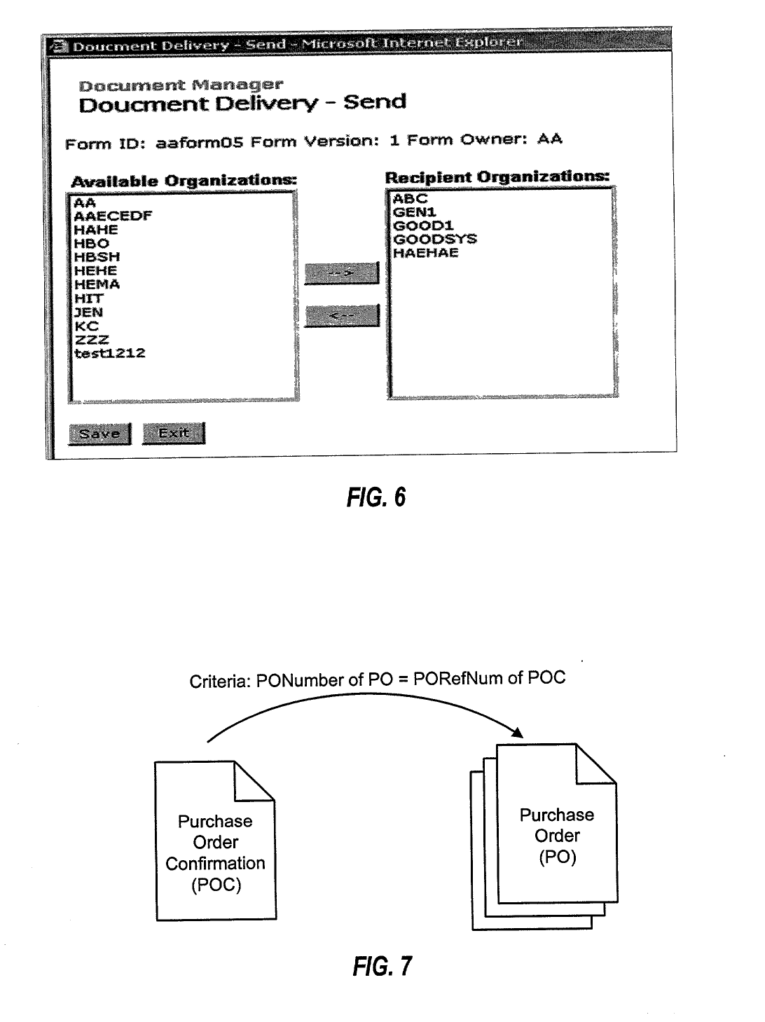

FIG. 6 is a diagram illustrating an implementation for configuring a delivery and response hierarchy. A document may be exchanged between organizations that have established a document exchange relationship. An administrator can configure which types of structured information can be sent by which sending party and to which receiving party. Such a configuration may also include the types of the originating information (e.g., a configuration may specify that a purchase order confirmation but not a quotation can be created from a received purchase order).

A document may be selected by a user for processing and delivery to one or more recipient users noted in the document. The recipient of a document may be a user, a group, or an organization. Any validation specified (e.g., by the document schema) to be performed prior to document delivery is performed before the delivery.

The delivery processing is performed by a document routing module within the iDEX system. A single document may be sent to multiple recipients. This may be advantageous in various situations such as, e.g., sending a Request for Quotation document to various suppliers, inviting multiple quotations for the same product(s), and so on. This functionality reduces duplication of documents and the time spent in preparing them.

Each document schema may be associated with a defined list of senders and recipient organizations capable of receiving documents created from the document schema. In an embodiment, each document can only be sent to users who have been granted access rights (e.g., by a document recipient administrator). To send a document successfully to a recipient, two steps are performed (1) an administrator of the sender's organization adds to a list of users who can send the document, and (2) an administrator of the recipient's organization adds to a list of users who can receive the document. For example, if user X in organization A wants to send a document to user Y in organization B, then the following conditions should be satisfied: (1) the administrator of organization A should add user X in the senders' list and organization B in the recipients' list for user X, and (2) the administrator of organization B should add user Y in the recipients' list and organization A in the senders' list for user Y.

A document may be sent to one or more recipients at the same time. In an embodiment, each recipient is provided with the sender's information but not information of the other recipients of the document. A document being delivered may also be carbon copied (CC) to other interested parties. The party receiving a copy can view the contents of the document and provide comments (collaboration) on the document though they may not be able to take part in the business transaction. For example, a delivery order raised can be sent to recipient(s) in the warehousing department as well as copied to the accounting department to help in the preparation of an invoice.

Once a document has been submitted for delivery, the sender can be informed of the status of the document upon delivery to the recipient(s). The iDEX system can email the sender an acknowledgment (ACK) if the document delivery is successful or a negative acknowledgment (NAK) if the delivery has failed. The sender can also specify that a notification be sent back when the recipient has opened the document. The sender may choose to either receive or not receive the ACK/NAK email via personalization settings, as described below. The sender may also adjust the ACK/NAK setting on a per document basis. Users can thus be given options to individually choose whether or not to receive these emails. In an embodiment, the administrator is notified when the delivery of an ACK/NAK email fails and the reason(s) for the failure.

A document residing in one iDEX system installation may be exchanged with another iDEX system installation. This messaging feature between two or more iDEX installations support information exchange between two different application service providers (ASPs) with separate installations of the iDEX system, where each installation is likely to have its own set of organizations and setup. This messaging feature facilitates document exchange between users belonging to different iDEX installations and hence increases the reach of the system and the organizations and users registered with the ASPs.

A document residing in an iDEX system installation may also be exchanged with other (e.g., legacy) systems that employ some common (conventional) messaging engines. This allows the users on the iDEX system to interface with users on these other systems, increases the reach of the iDEX system and the organizations registered with the ASP, and further leverages on the existing facilities. Application programming interface (API) processes may be used for this purpose, which enable the exchange of information and resources between the iDEX system and these messaging engines.

After a document has been received and read by a recipient user, the iDEX system can mark the document as having been read and indicate this to the user. This function enables the user to distinguish between documents that have been read and those still unopened, when a list of documents is displayed in a view. A set of read/unread records is maintained for each user.

Once a document has been sent to its recipient successfully, changes or updates can still be made to the document by the sender using an amendment function. When a document is amended, its version number is automatically incremented, indicating the latest version of the document. By default, when an amendment is made, all previous versions of the document are disabled and cannot be used to create a related document. The disabling function can be deselected to enable a previous version of a document to be used in creating a related document. Fields that have been amended can be visually indicated (with a change in color), and certain fields can be made read-only and mandatory.

Recipients of documents are granted access rights by the sender's organization. Depending on the granted access rights, a recipient can view, delete, reply to, approve, and reject the document. Documents can thus be sent, received, amended, and cancelled between organizations.

FIG. 7 is simple diagram illustrating how a new piece of information (e.g., a particular document) can be related to one or more existing pieces of information (e.g., another document) by preconfigured criteria defined by an administrator. Rules (e.g., matching field values of certain document schemas) may be specified (e.g., by the user) so that a new document, either newly created or newly received, can be related to one or more other existing documents. This allows a recipient of a document to create related documents from the received document and to allow the iDEX system to relate the received document to other existing documents, if such documents have been defined. This also allows a user to view the hierarchy of related documents of any particular document. In the example shown in FIG. 7, a purchase order confirmation is related to a received purchase order. By providing this feature, users may also easily identify related information (documents) without manual searching and filtering.

5. Document Flow

A document may be sent to various groups and/or users within an organization for review and approval before it is sent out to the final recipient. During the review process, the document may be given a different status as compared to when the document is exchanged between organizations. This feature allows users within various groups of an organization to track the stages of the review process for a document. Users have the ability to add notes and memos to a document being reviewed, and these notes and memos may be used internally to provide useful information to various groups and users during the review process.

A document may be created with implications to complete other documents. These documents are defined to be related, and a user is allowed or prompted to complete these documents together. The documents may then be sent in one process to either the same or different recipients, depending on how the documents are defined.

Context-sensitive flow may also be defined for a particular document to allow certain functions to be performed based on certain information. As a document is being completed, some sections or fields may be enabled or disabled based on a previous selection or information provided for the document. A particular reaction may occur (e.g., another document may be required to be completed) if certain criteria on the current document has been filled out and/or selected. For example, if “dangerous” has been selected for type of goods, then an export declaration form may need to be completed as well.

A status in a document workflow process may be reported to a user to notify the status of a document in the workflow once the document has been submitted. The workflow may be defined such that notifications are sent out to the recipients at certain stages of the workflow. For example, an email may be sent to a group of approvers when a user has submitted a document for approval. In advanced workflows, content-sensitive notifications may also be issued, based on the status of the document as well as information included in the document. For example, when a user submits a purchase order greater than a particular amount (e.g., $10,000), the workflow may require that a purchase requisition note also be made corresponding to this purchase order. If such a purchase requisition note does not exist, then the iDEX system can notify the user to create one before the purchase order can be processed further.

6. Document Management

Document Management. Various functions are supported by the iDEX system for document management. These functions include removal, archive, print, import, export, and so on.

Documents that are no longer required may be removed via soft-deletion (i.e., marking the documents as deleted but not actually removing the documents from the iDEX system) and hard-deletion (i.e., permanently removing the access rights for those documents). Soft-deleted documents are removed from the user folders. Soft-deleted documents have indicators in the views/folders, and the user can choose to “undelete” these documents. Permanent deletion of documents can be performed by a system administrator.

Documents on the iDEX system may be archived to another database or onto physical disk space by a system administrator. Documents may be selected for archiving based on some properties of the documents. Archived documents may thereafter be recovered, and the particular documents to be recovered may be selected based on certain criteria, e.g., the date of document creation.

Documents may be imported or exported from the iDEX system. The export function allows a user to download copy of a document from the iDEX system onto the local drive (e.g., to make a copy of the document for backup purpose). The import function allows the user to upload a document from local storage onto the iDEX server.

Various properties of a document are automatically recorded by the iDEX system. These properties may include (1) the dates and times when the document was created, last modified, and last accessed, (2) the size of the document, (3) the internal ID of the document, and so on. These properties may be used to easily retrieve a summary of document information and to report problems.

A document may be tagged with any arbitrary internal category by the creator of the document. This function enables a user to file documents into personalized categories, which may be maintained in a hierarchical structure. A list of categories is maintained for each user. The categories in this list are owned and visible only to the individual user, and the user can modify and add new categories to this list. A document may be tagged with any defined category included in the list. A tagged document may also be untagged.

One or more public folders may be created by a user within an organization and used to share documents with other users in the same organization. A user can add documents to be shared with other users within the organization into the public folders. Users of the same organization can access only those documents in the public folder for which they have been granted access rights. Each public folder may be associated with a set of users granted access rights to all documents included in the folder? Or are the access rights granted on a per document basis.

Locking Mechanism. A document may be locked to prevent it from being modified. This locking function may be used for various purposes including (1) to ensure that a document cannot be edited while another user is accessing it (for exclusive editing), (2) to indicate whether this document is available for editing at an early point in the document preparation cycle, which can provide an improved user experience, and (3) to maintain data integrity.

In an embodiment, the locking is achieved via a check-in/check-out mechanism. A document may be locked by marking it as being checked out, e.g., when it is being edited by a user. When a document has been checked-out, other users can only read it but are not able to modify it. When a checked-out document has been updated, it remains checked out unless (1) the user who checked out the document indicates that the document should be checked in or (2) the user no longer has edit access to the document after updating the document (e.g., when sending the document). After the checked-out mark on the document is removed, it can be accessed for editing by other users. In an embodiment, the check out is an automatic operation and no two users can check out the same document concurrently. An organization administrator has the right to mark any checked-out document as checked-in, overriding the right of the user who checked out the document.

7. Document Metadata Manipulation

Document Schema. A document schema describes the “semantics” of a document and comprises sections and fields. In addition, an administrator or a user with the appropriate access rights can specify whether new documents can be created based on the document schema from scratch (in contrast to documents that must be created based on some other existing documents). A document schema can be created (by an administrator) from scratch or from an existing document schema, and saved via several options, e.g., as a draft or a released schema. A draft document schema is a transitional version and cannot be used by users, and a released document schema may be accessed by users and used to create documents.

A section includes a standard set of fields that can be completed multiple times. Each document schema can include one or more sections (e.g., line item section), and each section can further include sub-sections. The iDEX system can thus support multi-level sections, including line items sections, in each document schema.

Each field of a document schema is identified by a unique name to distinguish it from other fields. Each field may be associated with (1) a data type, (2) validations such as characters, maximum and minimum lengths, and formats the field can accept, (3) a default value, (4) a mask, and (5) identified dependence on other fields. A data type for a field should be selected from among the available selections. A field may be mapped to predefined fields in an address book and/or a code list. A field may also include a formula to perform computations based on a value entered for the field and/or values from other fields. Each field can be edited and deleted by the user, and can include a meaningful textual description for display to the user (e.g., during validation failures). A field may also be associated with one or more system-wide standard fields.

A field may be mapped between any two document schemas (e.g., by an administrator), and a document schema may be associated with any number of field mappings. A computation (e.g., concatenation, addition) may also be specified for a mapping field. This field mapping feature facilitates data entry and ensures accurate document generation by allow a recipient of a document to create a new document by copying some field values from one or more other documents (which may not be based on the same document schema as for the new document). When a new document is created in response to one or more source documents, the default values for certain fields are first populated as specified in the document schema for the new document. Next, values for the mapped fields are copied from the source document(s) to the new document according to the mapping defined in the field mapping between the new and source document schemas.

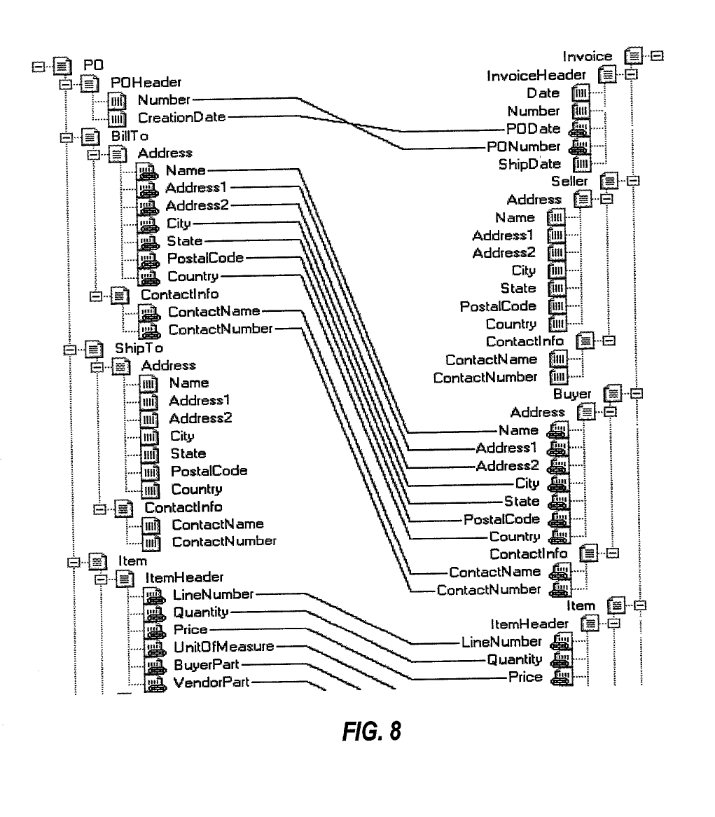

FIG. 8 is a diagram illustrating a data inheritance relationship, which is related to field mapping. The example shows how the data in a purchase order (on the left-hand side) can be mapped to an invoice (on the right-hand side). With the response hierarchy defining which type of information can be created based on an existing piece of information, this data inheritance feature enhances the framework by reducing the need for repetitive input by the user.

Document Layout. A layout is a particular arrangement of information for a document and has a particular “look”. A layout may be defined to include sections and/or fields. Each field may be specified. Text, graphics, and color may also be added to the layout to obtain the desired look. Tables with rows and columns may also be added, edited, and deleted. Items within a section may be moved by cut, copy, and paste operations. Changes in the layout may be made at any time, such as adding or removing fields and line items, text, fonts, graphics, horizontal lines, and colors (both to the background and to cells).

Specific line item and fields may be laid out plainly within one page or in a multi-level expandable format (i.e., a layout group). Hyperlinks may be added to a layout, and the link location may be either a static text or a formula that can render a value dynamically according to the values in other fields of the document. A layout group may be an inline expandable/collapsible layout or a pop-up window format. The layout group may include fields and line items. A line item section may be displayed in a pop-up window, or within the main document layout, or both options can be made available. Each line item section has its own customizable column-heading bar displayed on the document layout. Some or all field information may be selected for display in a heading row. This heading row allows the user to view the information contained in its respective field without having to actually go into the line item section.

Multiple layouts may be defined for a given document, such as a display layout for online reading and editing, a print layout to represent the printout format for the document under different environments (e.g., IE, Netscape, PDA, and so on). Multiple print layouts may also be created for a particular document schema.

In an embodiment, a layout may be copied once it has been saved. A duplicated layout may be left as is or may be modified based on the user's preference. A layout may be copied and used within an organization during layout creation, or it may be copied across organizations to be used during their layout creation processes.

Document Schema Management. Once a document schema is activated, all users with access rights to that document schema can use it to create new documents. All mapping features and related documents are also enabled with the document schema. Once a document schema is deactivated, all users with access rights to that document schema cannot use it to create new documents. All document layouts, field mappings, and rules for document relationship associated with a deactivated document schema become read-only, but are still valid. These types of documents cannot be amended.

The organization that creates a particular document schema can share it with users of other organizations so that these users may also create documents based on the document schema. To allow other organizations to share the document schema, a document exchange relationship needs to exist between the organization that owns the document schema and the organizations that will use the document schema. If a document schema is shared, its associated layouts are also shared. To share a document schema, the user administering the document schema selects the particular users allowed to share the document schema and defines the appropriate actions that may be performed with that document schema.

A document schema belonging to a particular organization (or to the iDEX system, if the user is a system-wide administrator) may be deleted. However, a document schema cannot be deleted if it has one or more existing documents associated with it. Once a document schema has been deleted, all associated layouts, field mappings, and rules for document relationships are also automatically removed. Once deleted, all organizations that have access rights to the document schema are not able to create a document based on the document schema. No new documents can be created from a template that is based on a deleted document schema.

8. Code Lists

Code Lists. Code lists may be defined and used for common code selection. Each code list may include one or more codes, and each code may be associated with one or more descriptions or multiple codes may be associated with a single description. To avoid data redundancy and to support different types of code list, the structure of a code list is typically defined first before creating entries for the code list. The structure may be hierarchical (i.e., able to be divided into multi-level sections).

A global code list may be created for the use of all organizations. Each organization can select codes from the global code list or create its own customized code list. Groups within an organization can choose codes from the organization code list or create their own customized code lists. Users may also maintain individual customized code lists that may be used in documents, and may also add, edit, and delete codes and their descriptions in their respective customized code lists.

Code lists can be imported and exported by the iDEX system and its organizations and groups. Code lists may be imported into the iDEX system from a file that includes codes and descriptions in a format recognizable by the system. Code lists may also be exported from the iDEX system onto local drives in a file having a format defined by the system. The format for importing and exporting code list may be proprietary or based on an open-standard and extensible data format (e.g., XML). A tool may be provided for editing the code list so that different file formats are supported.

9. Summaries and Reports

Page Navigation. Page navigation is supported by the iDEX system to allow a user to navigate between multiple pages of a document or report. On the Web, a user may need to navigate between pages for various situations. A document or a report may contain more than one page when being worked on or completed. If a restriction has been put on a particular view to display 10 document listings per page and the view includes 100 documents, then page navigation is used to browse through the various pages in this scenario. A user has the ability to go to the next, previous, first, and last page, where applicable. The number of the page(s) being shown and the total number of pages may be displayed (e.g., 1-10 of 100).

Search. One or more specific fields within documents may be searched to locate specific contents. Specific fields may be selected from a defined list of fields to build a search query. This defined list may include (1) fields on forms (e.g., main and sub-section fields), (2) iDEX system fields (e.g., header fields), and so on. Once a field has been selected, an appropriate operator and value are assigned to conduct the search effectively. Multiple fields may be selected to be searched concurrently and, depending on the setup of the search query, these fields may or may not have dependencies on other fields within the same query to meet one or more conditions in that query. After a search query has been invoked and completed, all relevant documents that meet the criteria of the query are displayed in a separate window. A search query may be saved for later use, and a user may have more than one saved search query.

Full-text search may also be performed on documents. In this case, the text to be searched is entered to build a search query. The query will then search all documents (i.e., the content of every field within each document) for the text specified in the query.

View. A view may be created and saved for viewing documents on the Web. Multiple types of view are supported by the iDEX system, such as public view and private view. A public view may be accessed by all users under the same organization (and is saved by a view administrator) and a private view can only be accessed by the user who created the view.

A view may be defined to include one or more columns (which may be selected by a user), and a heading may be entered for each column. Each column may correspond to a particular field defined in a document schema to which the user has been granted access, a standard field, or a computation formula for the column. A column may also be specified to represent a hierarchy of related documents and/or a list of comments made regarding that document. One or more columns may be specified to contain links for the user to click on to access the entire document.

A view can be customized to a user's preference via various options. The width of each column may be adjusted to allocate sufficient space for displaying the relevant field information. Different colors, sizes, and fonts may be selected for the headings. Optional sorting order of the column and whether the column is collapsible may also be specified.

The text, font, color, and graphics to be displayed on the view may be defined. A listing structure for displaying documents may be selected from among a number of available choices such as expandable views and one-level document listing (i.e., showing the latest version of a document on the top level and expandable to display all historical documents). The number of document listings per page may also be defined.

A view may be configured to display only relevant documents. One or more fields may be selected and assigned values or restrictions to define selection criteria that should be met by a document before being listed on a particular view. Multiple selection criteria may also be defined for a single view. A user may specify if one, some, or all of the defined selection criteria need to be met by a document before being displayed on the view. If the fields in a document do not meet the specified criteria, then the document is not displayed on the view.

A particular document and its related documents may be listed and viewed, after the relationships between documents have been defined as described above. This function enables a user to keep track of the status of a business transaction. The user can view a list of all related documents to date and the details of each of these documents. The user may or may not be able to edit the related documents, depending on their states and the user's access rights. The list of related documents can display the original and amended versions of all documents sent and received. For example, if a Quotation has been created in response to a Request for Quotation and is later amended, then the related documents for the Request for Quotation can display two versions of the Quotation.

View Management. Each view may be activated for use or deactivated from use (e.g., by the view administrator). Once a view is activated, all users that have access rights to the view can use it to view their list of documents. All menus, functions, and forms related to the activated view are enabled and displayed. Once a view is deactivated, all users with access to the view are not able to use it to view their lists of documents. The deactivated view can still be seen in the list of all views in the menu section, but cannot be selected for document listing, indicating it has been deactivated. If a deactivated view has been selected as the default view for a particular user, the iDEX system will inform the user (upon log-on) that the default view is deactivated and will prompt the user to select a new default view.

A particular view from a list of views that belong to a particular organization may be selected and deleted. Once deleted, the view does not appear in the list of views in any organization that has access rights to the view.

A view that has been saved may be duplicated. A duplicated view may be left as is or may be modified according to the user's preference. A view may be copied and used within an organization or copied across organizations to be used by other organizations for document listing. A view that has been copied within an organization is renamed to distinguish between the original and copied versions. A view that has been copied across an organization is given a unique name among that organization's views. The iDEX system performs an integrity check function for views, forms, and fields matching.

User and Document Tracking. User activities can be tracked when documents are created, sent, received, amended, deleted, copied, cancelled, and saved between and within organizations to monitor the flow and manipulation of documents between and within organizations. A detailed report on usage may be generated for the activities of each user within an organization. The report may include items such as the duration users have been logged on, the activities or services performed or used by the users, the documents accessed, the manipulations performed on the documents, and so on. This tracking feature may be used to (1) track the operations performed by individual users in an organization, (2) monitor the appropriate actions taken by the users, (3) track the efficiency rate of the individual users, (4) verify the correct use of the documents being exchanged, and so on.

Document Audit Trail. An audit trail may be generated for a particular document to list the stages that the document has been through. The audit trail summarizes all actions that have been carried out on the document, the specific users who performed the actions, and the date and time when the actions were performed. Whenever a user opens a document and performs an operation on the document, which results in some processing of the document, an audit record is generated and attached to the document. An audit trail of a given document may then be generated (automatically by the iDEX system) based on all audit records previously generated for the document. In an embodiment, an audit record is not generated if a document is simply opened by a user and no processing is performed on the document. However, if a document is saved, submitted, or copied, an audit record is generated since any one of these actions results in processing of the document. Any user with read access rights to a document may view the document's audit trail.

Reports. A report may be prepared in a formatted fashion to enable the display of information more suitable for viewing and/or printing. If a report has some parameters that need to be specified, then a user may be prompted for these values. The selection criteria are then used to generate and display the formatted report. A formatted report with its parameters may be defined and rendered through WYSIWYG tools and technology.

A customized report may also be generated for various purposes (e.g., analysis) if the standard set of reports provided with the iDEX system is not sufficient. An organization administrator may create, edit, and save customized reports. Access to the customized reports may be restricted to certain users, and provision may be added to save those queries that have been setup so that the users may re-use these queries. The queries may then be used to generate customized reports to suit the preferences and purposes of the individual users. The customized reports generated by the queries may also be associated with some formatted and/or unformatted printing capability.

Printing Documents. A document that can be viewed (i.e., with the proper access rights) may be printed to generate a hard copy. Documents may need to be printed, e.g., in organizations required to maintain hard copies of documents for their business transactions. A user may directly print the Web page on which a document is displayed. The user may also print the document using a formatted printing option, which allows the content of the document to be arranged and structured according to some defined format specifications.

10. Personalization

Various features are supported by the IDEX system to allow a user to personalize the individual account and work environment. The iDEX system supports multiple languages, currencies, date/time formats, and so on. Each user can select a preferred language, date/time format, and currency from a list of possible values. This information is then used to display fields, labels, and text in the appropriate formats. The currency symbols to be displayed are based on the particular currency selected by the user. A user may also set an individually selected password after verifying the old password.

The behavior of certain actions may also be customized by a user. These actions include requesting warning/confirmation messages to be displayed, visual and audible alarms when some events or actions take place, and others. For example, a user may specify whether a confirmation message should be displayed before a document is deleted or saved.

A public address book includes entries that may be used by all users in an organization, and may be created and maintained by an administrator. A private address book includes entries that can be accessed only by the user who owns it, and each user can create and maintain an individual private address book. Maintenance of entries in an address book includes adding, editing, viewing, and deleting entries and these actions can be performed only by the owner of the address book. General users may only view and select entries from the public address book.

A user may customize the actions to be performed by the iDEX system upon occurrence of certain specified events. The iDEX system may maintain a list of events and the associated possible actions, and the user may use the list to match an event with the desired action. Some examples of event-action pairing include (1) requesting an email notification when certain new documents arrive, (2) automatically transferring certain documents between specified folders and deletion of documents from folders, (3) requesting success and failure notifications during document delivery, (4) refreshing views after each particular time interval (e.g., n minutes), and so on. These personalization options (1) allow a user to reduce the amount of manual work that may result in erroneous handling of documents and (2) further provide the user freedom to focus on events that are more significant in the business process cycle.

11. Security

Various mechanisms are used to ensure the authenticity and integrity of documents. A digital signature may be used to sign a document to be delivered over a computer network (e.g., the Internet) to assure the recipient of the authenticity of the delivered document. The sender signs the document with a private key before sending it to the recipient. The recipient receives the document and verifies the signature on the document with the sender's public key. If the signature passes verification, then the recipient is assured that (1) the content has not been modified and (2) the identity of the originator of the document.

Encryption may also be used to ensure that users have access only to relevant data and at the proper time. The iDEX system supports industry standard encryption to ensure that data is not sent out in plain network packets. Encryption prevents third or unauthorized parties from compromising data during transmission. Digital certificates and SSL technology may be used to ensure tight security and data encryption. Encryption of passwords is also supported to protect user privileges and data.

12. Access Control

By default, a system administrator has all the rights to the iDEX system. When the system administrator registers an organization, administrative rights for that organization is assigned to an organization administrator. The organization administrator may assign access rights to various groups or users for different objects. Different types of access rights are also available depending on the types of objects. For example, access rights for a document object may include create, delete, amend, cancel, approve, and so on, and access rights for a user object may include create, delete, and so on.

13. iDEX System Design

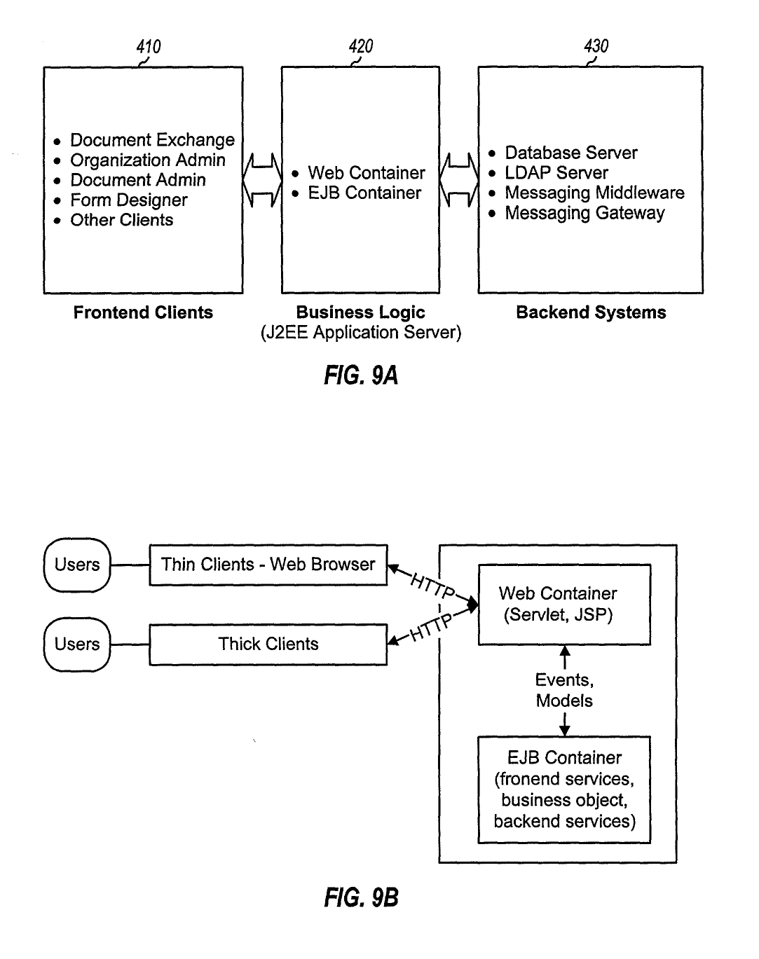

FIG. 9A is a block diagram of a multi-tier architecture used for the iDEX system. In an embodiment, the iDEX application service is implemented with a three-tier architecture and is designed to reside in a J2EE environment. The three-tier architecture includes a front-end 410 that interacts thin clients and thick clients, a business logic layer 420 hosted by a J2EE application server cluster, and a back-end 430 implementing and/or supporting legacy systems such as database server, LDAP server, and so on.

As shown in FIG. 9A, business logic layer 420 is further divided into two application containers, as suggested by the J2EE Specification. A Web container serves the Web specific components (e.g., Servlet, Java Server Pages (JSP), and other supporting objects). An EJB container serves the Enterprise Java Beans (EJB). There are two types of EJBs, namely session beans and entity beans. Session beans are mainly used for executing business logic, and entity beans are used for representing business object entities. The J2EE architecture is described in further detail in the Java 2 Enterprise Edition Specification, which is incorporated herein by reference.

In an embodiment and as implemented in the iDEX system, objects providing service to front-end 410 are modeled as session beans, while business objects such as document, document schema, users, and others, are modeled as entity beans. In addition, there are session beans that provide back-end services such as document delivery from one organization to another. All of these EJBs, along with the supporting classes, reside in the EJB container. The objects in the EJB container are responsible for managing the application services and business data.

FIG. 9B is a diagram that shows the interaction between different types of clients and the EJB container to support interaction with the users. In an embodiment multiple types of clients are supported by the iDEX system including thin clients and thick clients. A thin client may be a Web browser-based user interface that interacts with the iDEX system via, e.g., HTTP. A middle layer (i.e., the Web container) handles an HTTP request from the Web browser, converts the request to an iDEX event for the services residing in the EJB container, renders the result, and sends it back to the client as an HTTP response. A thick client is similar to a thin client except that it is not dependent on a Web browser. More complex functionalities that are not easily handled in the Web browser may be implemented with a thick client.

In the iDEX system, the containers are configured to manage the connections to the backend services, such as the database server. These containers can use intelligent strategies like database connection pooling to reduce the cost of communication with the backend services. Since different implementations of the J2EE application servers for the backend services are possible, Factory Method design pattern can be applied to shield the iDEX objects from the possible platform dependency caused by using container-managed services.

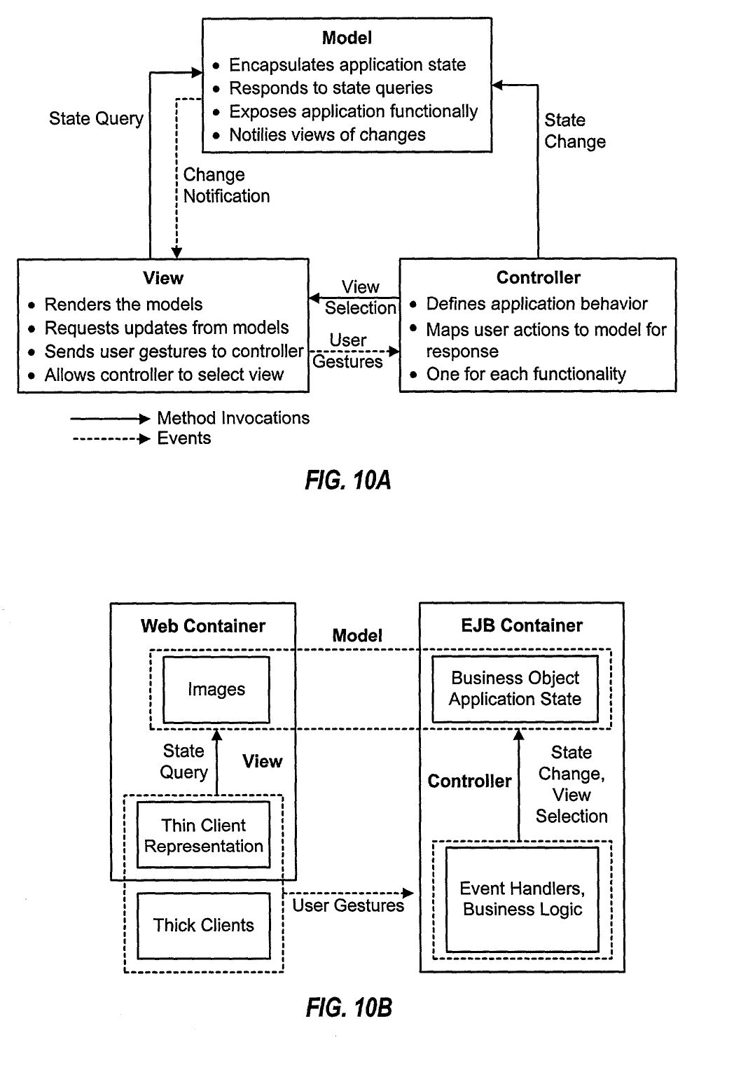

FIG. 10A is a diagram of a model-view-controller (MVC) architecture. The MVC programming model logically separates an application into three layers Model, View and Controller. The Model layer is responsible for storing application data. The View layer is responsible for interfacing with the user, which involves the presentation of data, and obtaining user inputs. The Controller layer is responsible for logic evaluation. It takes the input events from the View layer, performs necessary computation, and makes changes to the Model layer.

FIG. 10B is a diagram of an implementation of the MVC architecture in the iDEX system. In the iDEX system, the View layer comprises the thin clients and the thick clients. The thick clients retrieve the objects from the Web container and handle the presentation and manipulation of the objects directly. In contrast, the thin clients are represented by the objects in the Web container, which also belongs to the View layer.

The Controller layer comprises a collection of objects in the EJB container that represent the business logic and are responsible for routing and processing events.

The Model layer comprises objects in the EJB container that store data and represent persistent business objects such as documents, users, views, folders, and so on. The Model layer also includes temporary objects such as action menus, application states, and others.

The View layer queries the Model layer for information to present to the clients. In order to minimize the communication between the Web and EJB containers (possibly costly network traffic), the Model layer is extended to the Web container. The architecture defines simplified image objects in the Web container to mirror the real objects in the EJB container. These image objects cache the states of the real objects, and are only updated when necessary.

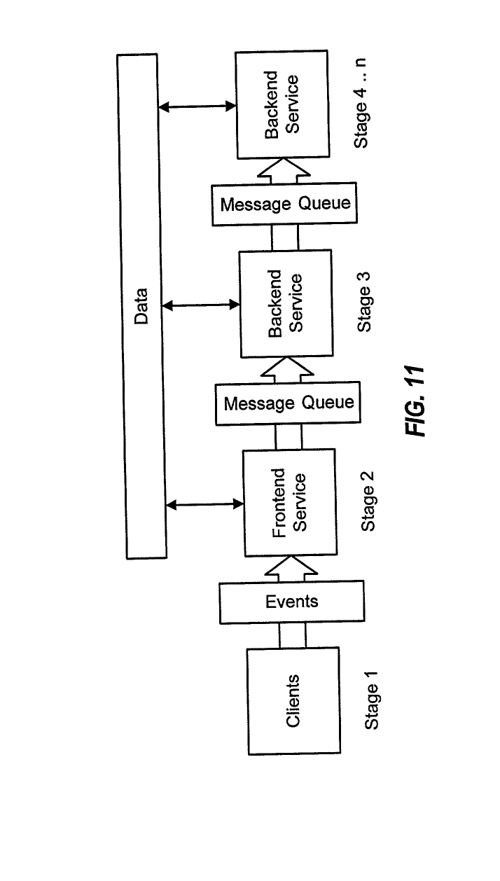

FIG. 11 is a diagram of a message-oriented system queue for the iDEX system, which supports a high-scalability low-coupling architecture. The system queue divides the iDEX application services into two groups: frontend and backend. The frontend services are event driven objects with the primary goal of providing short turnaround time services to the clients, to enhance the user experience. The backend services are message driven objects that perform post-processing of user events. These services may be scheduled to occur at a specific time period or assigned lower priorities, so that precious CPU cycles are not used to perform tasks that do not need to take place right away. This architecture effectively divides the system into a pipeline with three or more stages.

By implementing the message-oriented system queue, the iDEX system may be flexibly deployed in various manners in a clustered environment. The iDEX system may be deployed symmetrically, where every machine runs a complete iDEX system. The iDEX system may also be deployed asymmetrically, where one machine may be dedicated to handle the frontend services, and another machine may be dedicated to handle the backend services. The iDEX system may also be deployed in a mixed installation.

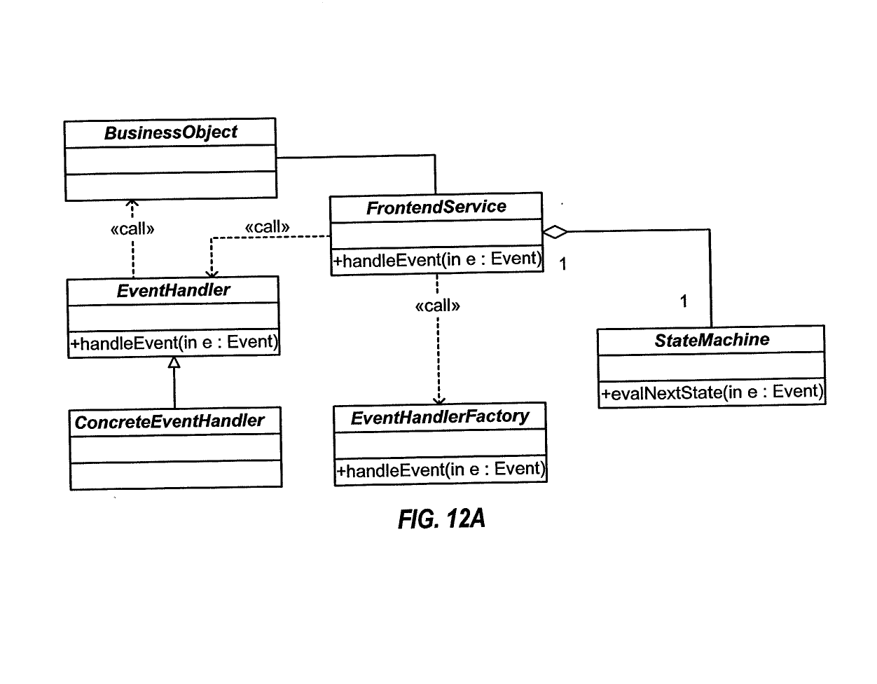

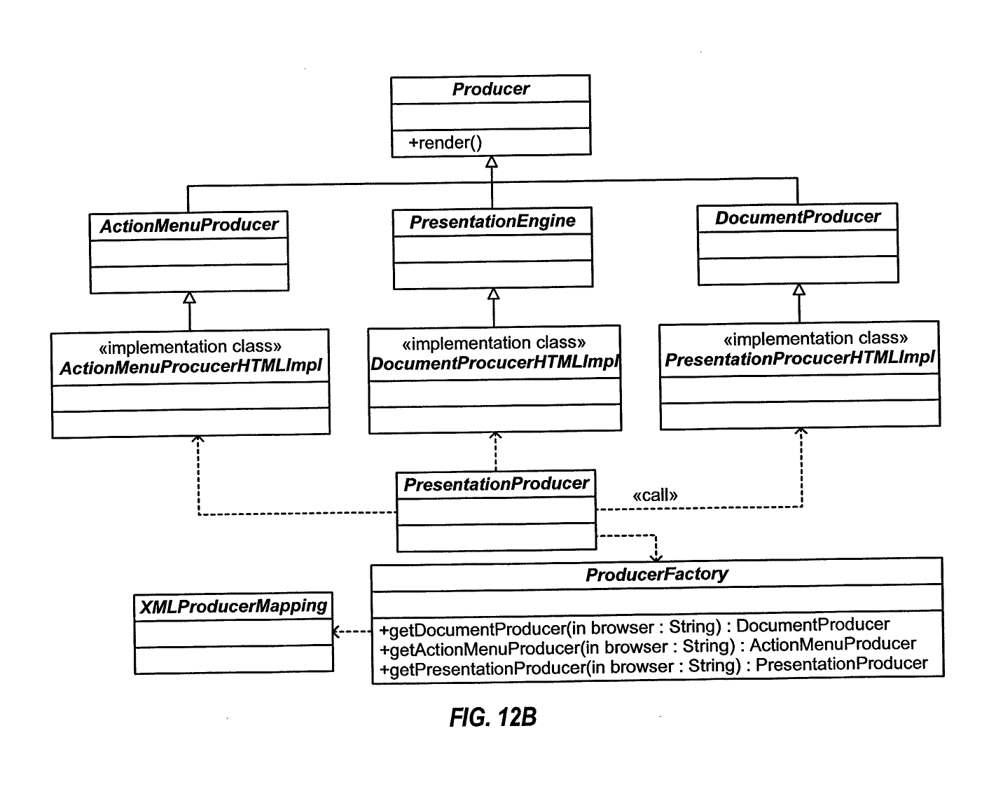

FIG. 12A is a diagram of an event driven finite-state-machine architecture for the iDEX system. The frontend services are modeled as event driven finite-state machines, an architecture that allows for high flexibility and reusability. This architecture includes three major components—service object, EventHandler, and StateMachine. The service object is the main object that routes events to appropriate event handlers and farther manages the relevant business objects. The EventHandler objects represent the actual business logic for handling requests. Each event handler handles a specific type of event, which allows changes to business logic and additions of new events to be localized. A Factory Method design pattern may be applied so that the service object is not aware of differences, if any, in the event handlers. The StateMachine encapsulates state changes in the service object. The use of the StateMachine allows most of the event handlers to act regardless of the current state.

FIG. 12B is a diagram illustrating a producer architecture for the iDEX system. In an embodiment the iDEX system is implemented to be browser independent. However, different browsers may support different sets of the HTML specification. Future browsers may also support different sets of markup language (e.g., WML). The producer architecture is employed to interface with different browsers with possibly different capabilities. The producer architecture is typically used for thin clients where the presentation is generated on the server side.

The producer architecture views a presentation stream (e.g., HTML, WML, XML) as a tree of components. Each of the components in the tree is represented by an object in the iDEX system. The producer translates the objects for the components into presentation sub-streams. A default producer is created for each class of object and is used to generate industrial standard presentation sub-streams, such as in standard HTML 4.0 format. If a specific browser cannot receive the standard HTML 4.0 format, then a special producer can be created for generating a sub-stream that is compatible with this browser. The selection of producers for specific browsers can be defined in an XML file during deployment. The producer architecture provides a plug-and-play environment for producing browser-specific streams, thus increasing the extensibility, reusability, and portability of the iDEX system.

JavaServer Page (JSP) technology may be used in the Web container to handle the layout of business objects in a page, and tag libraries may be used to glue the JSP with the presentation producers. An application service provider (ASP) deploying the iDEX system can lay out the business objects according to their need.

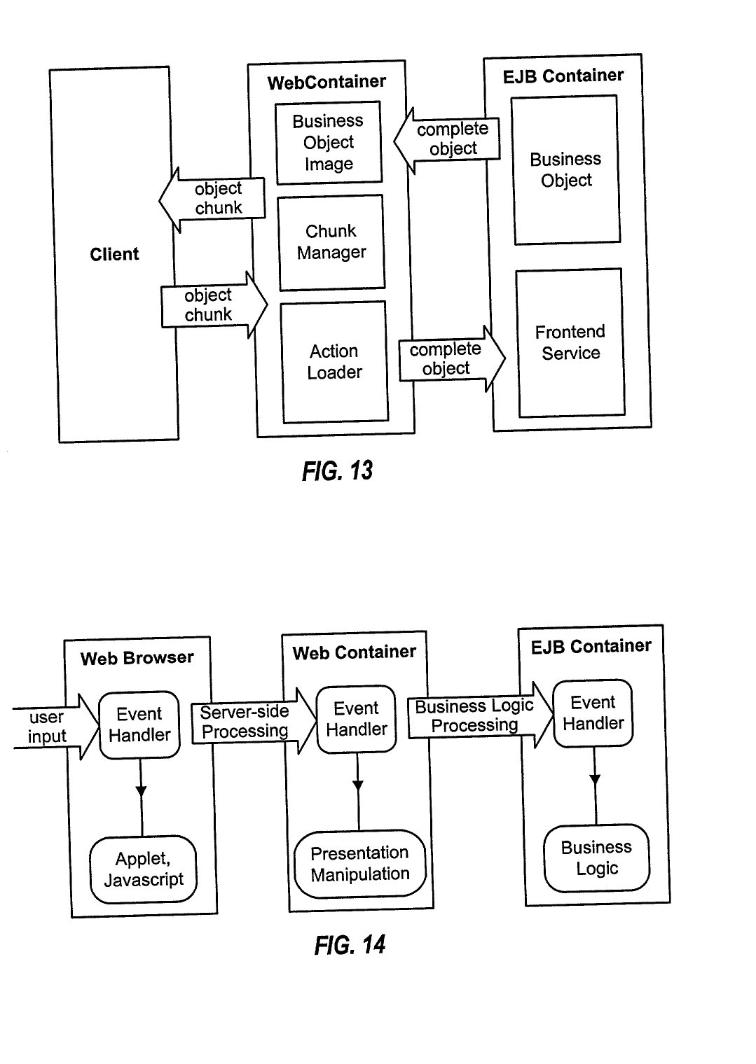

FIG. 13 is a diagram illustrating a server-side caching architecture used for the iDEX system. For a multi-tier design such as the one described above in FIG. 9A, the communication between each tier may potentially be costly from a performance perspective. To reduce unnecessary communication time, caching is used where applicable. An example of such caching is described above in FIG. 10B for the Images of the Model layer.

In an embodiment, caching is also used for the Client-Server communication. When a document contains a large number of line items, it typically takes a long time to transmit and load the document. To reduce the amount of data to transmit to the client to improve the user experience, a document may be partitioned into smaller “chunks” (i.e., portions) and each chunk may be transmitted on request. By breaking up a document into smaller chunks, the data size per request is effectively reduced. However, the number of transmissions also increases. Such trade-off may be significant if every one of the requests has to be directed to the EJB container for processing. To remedy this potential bottleneck, caching may be used in the Web container, as shown in FIG. 13.

The caching architecture shown in FIG. 13 creates tight coupling between the client and a Web container. When a request is received by an Action Loader within the Web container, the generated events may be routed to the EJB container for business logic processing or to a Chunk Manager within the Web container. If load-balancing is employed (described below), a load-balancing manager can make sure that once a session is established, the requests for this session are routed back to the same Web container.

FIG. 14 is a diagram illustrating an event-passing model used for the iDEX system. When a Web browser receives a user input, such as a click on a button, which generates an action for the iDEX system, a first event handler within the Web browser intercepts the user input. If the event can be processed using Applets or Javascripts residing in the current page, then the event is handled on the client side. However, if the request requires server-side processing, then a URL request is sent to the web server, which in turn forwards it to the Web container for further processing. A second event handler (i.e., the Action Loader) receives and handles the URL request. If the Web container has enough resource to process the request and no business logic is needed, then the request is handled in the Web container. Such a request typically involves presentation manipulation or cached processing, which may be supported by the Chunk Manager described above in FIG. 13. But if business logic is involved, an event is sent to the EJB container for further processing.

The event-handling capability of the frontend services is extended to the Web container, creating a structure that resembles one suggested by a Chain-Of-Responsibility design pattern. The Chain-Of-Responsibility design pattern isolates the sender of a request from its receiver by giving more than one object a chance to handle the request, chains the receiving objects, and passes the request along the chain until an object handles it. The Chain-Of-Responsibility model differs from the pipeline architecture described above in FIG. 11 in that the events are processed without delay in the Chain-Of-Responsibility model.

The use of server-side caching can complicate the overall system architecture since manipulation of business objects is no longer localized in the EJB container. The Chain-Of-Responsibility model ameliorates some of the possible adverse effects due to server-side caching.

In an embodiment, the iDEX system employs a “little” language for expressing filtering criteria down to the document-field level. The little language may be further expanded and used to describe other field level relationships such as document relationship rules and field mapping rules. The little language may also be used for document calculation and validation. Maintaining a single language for various tasks can reduce the programming effort and standardizes the way to handle expressions. The use of the little language architecture maximizes reusability for the parser objects and allows great flexibility in the iDEX system.

The little language may be designed using a well-defined process, which usually involves a parser and a lexical analyzer. Alternatively, the little language may be defined in XML, in which case a XML parser can be reused. Various factors such as expandability can be considered in the design of the language.

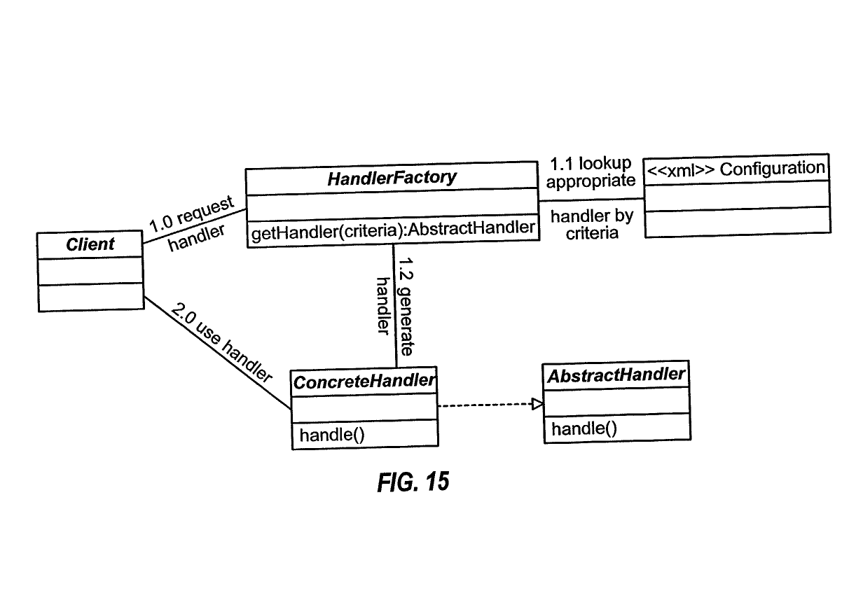

FIG. 15 is a diagram illustrating a request handler design model for the iDEX system, which is also referred to as a configurable handler framework model. This model provides a framework that allows easy integration of new components. In an embodiment, XML is used as a glue language. Combining such strategy with the Factory Method design pattern, a plug-and-play architecture can easily be defined. An example of such an architecture is described above in FIG. 12B.

The iDEX system employs the configurable handler framework model in many places to facilitate a plug-and-play architecture. The configurable handler framework model can be used (but not limited to) in the following:

Browsing Environment—Producer Mapping (Web tier)

URL Request—Request Handler Mapping (Web tier)

URL Request—Screen Flow Handler Mapping (Web tier)

Event—Event Handler Mapping (EJB tier)

Paper Size—Standard Paper Size (Client)

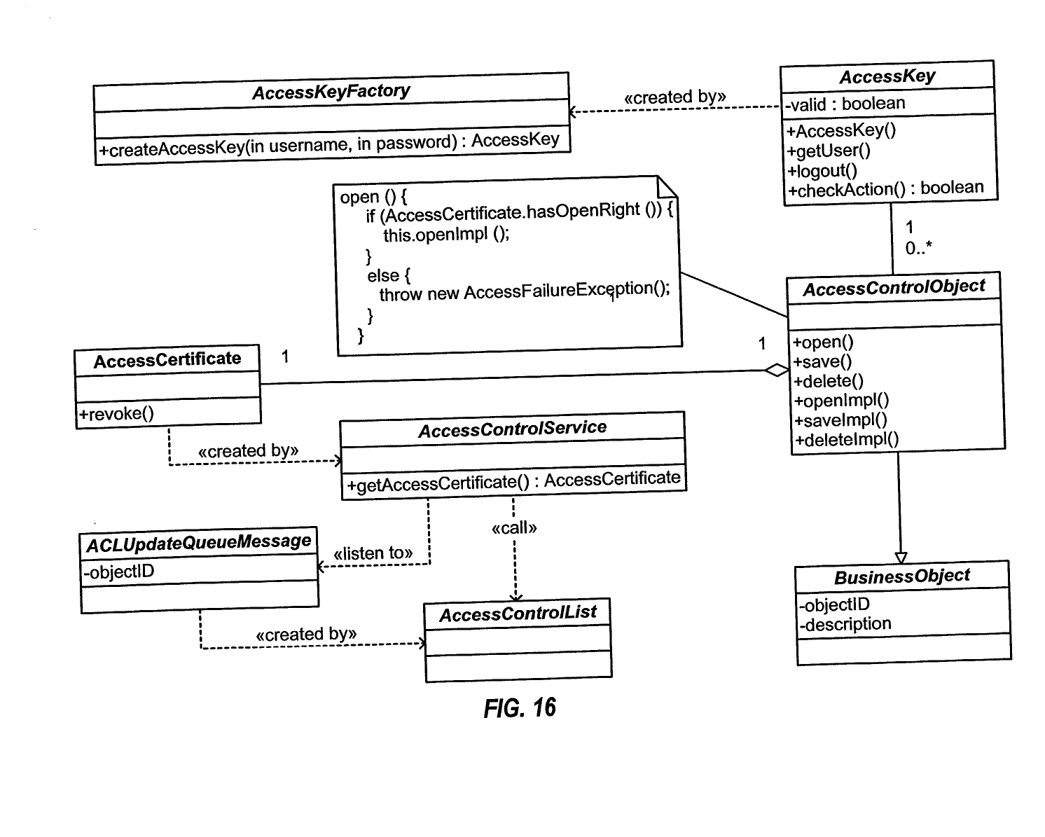

FIG. 16 is a diagram illustrating a security model for the iDEX system. In an embodiment, the iDEX system implements a dynamic security model where access control is defined at the instance level (e.g., a specific User may have a particular access right on Instance X of Class Z, but may not have access right on Instance Y of the same class).

The security architecture for the iDEX system is similar to that defined by the J2EE specification where different access rights may be defined for different operations of the same EJB object. This architecture is supported by defining an AccessControlObject abstract class and requiring every object that requires access control to be a subclass of this class. If an operation, op, is to be protected, then the AccessControlObject class defines an op operation that checks for the required access rights. If the security check passes, the op operation calls the opImpl operation, which is abstract to the AccessControlObject and is implemented by the subclasses. The opImpl implementation includes the necessary business logic for carrying out the operation.

Another object that facilitates the iDEX security model is an AccessKey. To interact with protected objects, the user is required to login to the iDEX system at the start of a session. If the login is successful, an AccessKey is generated and assigned to the user for the session. When the session is terminated, the iDEX system invalidates the AccessKey so that objects that may keep a reference to the AccessKey cannot use the key anymore. When an AccessControlObject is accessed, the session acquires an AccessCertificate using the AccessKey. The AccessCertificate records all the access rights the user has on the specific object.

There are cases where a user's access right regarding a specific object changes while logged in. This may happen when the administrator directly modifies the access right or indirectly modifies it by changing the user's group membership. In an embodiment, the AccessCertificate is revoked when such access changes occur regardless of the manner. The AccessCertificateFactory keeps track of the AccessCertificates it issues and revokes them when a change occurs.

In an alternative embodiment, a security model similar to that specified by the J2EE architecture may be employed. The J2EE architecture specifies that a J2EE container should implement container-managed security, and the security model for the J2EE architecture defines access control at the class level, with the user groups being defined at deployment time.

In an embodiment, the iDEX system supports versioning for document and document schema. To support versioning, an object in question includes two identities: an identity for referring to different versions of the same object as different entities (i.e., a Physical Identity) and an identity for referring to the different versions as one object (i.e., a Logical Identity).

In an embodiment, objects are grouped into “packages” to support a high coherence, low coupling design. Interactions between packages are simple and well defined (low coupling). The concept of each package is clear and self-contained (high coherence). An architectural design that follows this guideline will have a package structure that is relatively stable throughout the software development life cycle.

From an object model's point of view, a thin client is represented by two packages: a package that handles HTTP requests and responses (the Web-tier package) and a package that handles the presentation of objects to the Web browsers (the rendering package).

The Web-tier package contains an ActionLoader object for handling action requests and an ImageLoader object for handling image requests. The ActionLoader object further divides the responsibilities into three groups: a RequestProcessor object for passing the requests to the EJB layer for further processing, a ScreenFlowProcessor object for handling the screen flow on the Web browser, and a PresentationEngine for actually presenting the screen to the client. The PresentationEngine belongs to the rendering package. The ImageLoader object bypasses the EJB container and directly queries the database for the requested image object.

To support a configurable design, the Configuration via XML design pattern is used for translating requests into RequestHandler objects and ScreenFlowHandler objects. Since a request may not require backend handling or a special screen flow handling, the RequestProcessor and ScreenFlowProcessor objects define a default operation for non-specific actions.

A RequestHandler object is responsible for translating requests into Events. The RequestProcessor then passes the Events to the EJB container for further processing. To obtain a good object design, an IDEXSessionWebImpl object is defined to represent the IDEXSession service in the Web container. This object provides the interface for handling Events and answering status queries from the rendering package.

A thick client includes tools that bypass the Web container and connect to the EJB container directly. A client is considered thick because it is typically a complicated program that manages a graphical user interface (GUI) and provides client side processing functions. Each thick client resides in its own package, which in turn resides in the admintools package.

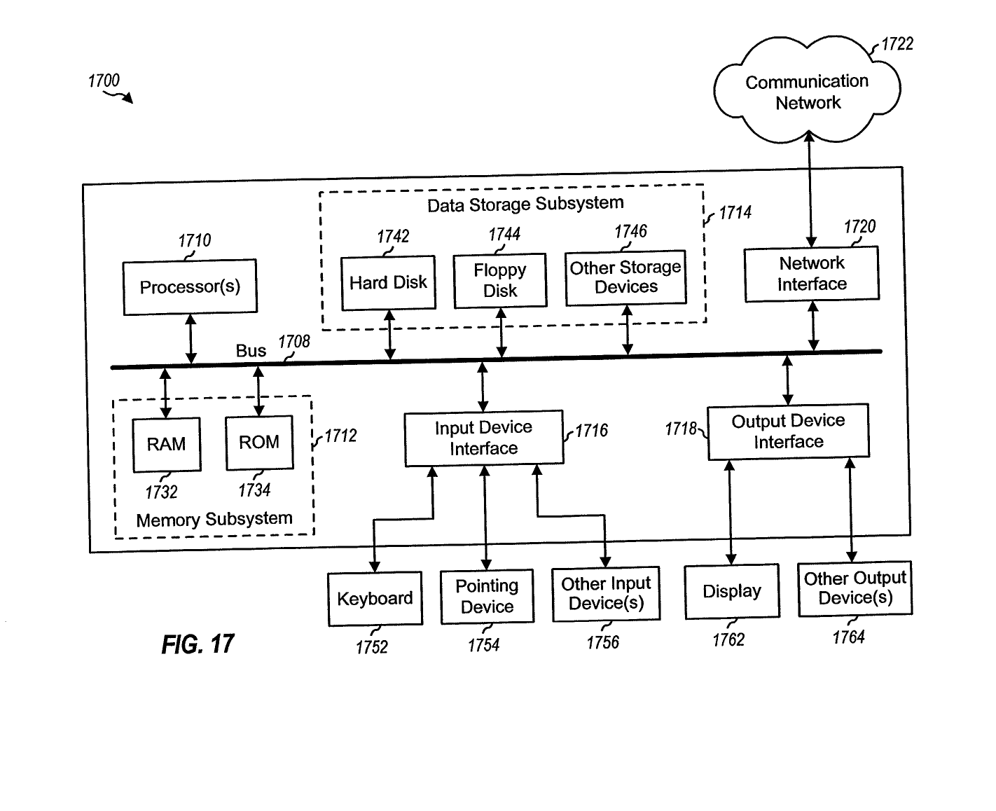

FIG. 17 is a block diagram of an embodiment of a computer system 1700 that may be used to implement the iDEX server in FIG. 2. System 1700 includes a bus 1708 that interconnects major subsystems such as one or more processors 1710, a memory subsystem 1712, a data storage subsystem 1714, an input device interface 1716, an output device interface 1718, and a network interface 1720. Processor(s) 1710 perform many of the processing functions for system 1700 and communicate with a number of peripheral devices via bus 1708.

Memory subsystem 1712 may include a RAM 1732 and a ROM 1734 used to store codes and data that implement various aspects of the invention. In a distributed environment, the program codes and data may be stored on a number of computer systems and used by the processors of these systems. Data storage subsystem 1714 provides non-volatile storage for program codes and data, and may include a hard disk drive 1742, a floppy disk drive 1744, and other storage devices 1746 such as a CD-ROM drive, an optical drive, and removable media drive.

Input device interface 1716 provides interface with various input devices such as a keyboard 1752, a pointing device 1754 (e.g., a mouse, a trackball, a touch pad, a graphics tablet, a scanner, or a touch screen), and other input device(s) 1756. Output device interface 1718 provides an interface with various output devices such as a display 1762 (e.g., a CRT or an LCD) and other output device(s) 1764. Network interface 1720 provides an interface for system 1700 to communicate with other computers coupled to communication network 1722.

Many other devices or subsystems (not shown) may also be coupled to system 1700. In addition, it is not necessary for all of the devices shown in FIG. 17 to be present to practice the invention. Furthermore, the devices and subsystems may be interconnected in configurations different from that shown in FIG. 17. One or more of the storage devices may be located at remote locations and coupled to system 1700 via communication network 1722. The operation of a computer system such as that shown in FIG. 17 is readily known in the art and not described in detail herein. The source codes to implement certain embodiments of the invention (e.g., source codes for the applications shown in FIG. 2) may be operatively disposed in memory subsystem 1712 or stored on storage media such as a hard disk, a floppy disk, or a CD-ROM that is operative with a CD-ROM player.

Headings are included herein for reference and to aid in locating certain sections. These headings are not intended to limit the scope of the concepts described therein under, and these concepts may have applicability in other sections throughout the entire specification.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A single-platform system for facilitating creation, exchange, presentation, and management of documents to support business transactions, and further operable for linking to and integrating with legacy systems and messaging gateways and other enterprise information systems, the system comprising:
a first module for configuring semantics of structured or semi-structured information;
a second module for configuring presentation of structured or semi-structured information; and
a third module for presenting the structured or semi-structured information using metadata from the first and second modules, wherein the third module presents the structured and/or semi-structured information in a media such that the information is modifiable, readable, printable, or a combination thereof.

2. The system of claim 1, further comprising:
a fourth module for configuring business logics, wherein the business logics include data inheritance between structured information, rules for linking related pieces of information, response hierarchies, or a combination thereof.

3. The system of claim 1, further comprising:
a fifth module for configuring relationships or access control, or both, of entities participating in a business application.

4. The system of claim 1, further comprising:
a sixth module for configuring one or more preparation cycles of the structured or semi-structured information, wherein the one or more preparation cycles comprise comments and approvals.

5. The system of claim 1, further comprising:
a seventh module for configuring translation of information from one format to one or more other formats for messaging to other systems or storage.

6. The system of claim 1, further comprising:
a set of administration modules configured to provide a platform enabling multiple types of business application systems to be implemented, deployed, modified, and maintained.

7. A computer program product operative to facilitate creation, exchange, and management of documents to support business transactions, comprising a computer-usable medium having embodied therein computer-readable program codes for
configuring semantics of structured or semi-structured information;
configuring presentation of structured or semi-structured information; and
presenting the structured or semi-structured information using metadata from the first and second modules, wherein the third module presents the structured and/or semi-structured information in a media such that the information is modifiable, readable, printable, or a combination thereof.

8. A system for facilitating creation, exchange, presentation, and management of documents to support business transactions, comprising:
a first module operative to provide tools for defining document schemas, wherein each document schema describes a data structure of a document and includes a set of fields for structured or semi-structured information, wherein the document schemas specify how data for documents should be stored and accessed for processing, and wherein the documents are representative of business transactions between entities;
a second module operative to provide tools for defining one or more user interface layouts for each document schema, wherein each user interface layout allows for presentation of, and data entry, for documents generated based on the associated document schema;
a third module operative to provide tools for defining a workflow for a business process, wherein the workflow defines exchanges of a set of one or more documents among a plurality of entities associated with the business process, and wherein each document in the set is associated with a particular transaction between a pair of entities; and
a fourth module operative to facilitate presentation of, and data capture for, documents using the user interface layouts defined for the document schemas associated with the documents, and further operative to receive captured data for documents and compile the data into the data structures described by the associated document schemas for storage and processing.

9. The system of claim 8, wherein the document schemas and workflow are coupled so that changes to definition of a particular document schema do not require changes to definition of the layout or are automatically propagated to the definition of the layout.

10. The system of claim 8, wherein the tools and processing engine are coupled so that changes to definition of a document schema do not require changes to definition of the workflow or are automatically propagated.

11. The system of claim 8, further comprising:
a fifth module operative to process the documents for the workflow in accordance with the work flow.

12. The system of claim 11, wherein the fifth module is further operative to facilitate exchanges of documents among entities for the workflow.

13. The system of claim 11, wherein the fifth module is further operative to perform data inheritance between related documents at document creation.

14. The system of claim 11, wherein the fifth module is further operative to perform data linking between related documents upon receipt and creation of the documents.

15. The system of claim 8, wherein the workflow defines a specific order for exchanging the documents in the set.

16. The system of claim 8, wherein the workflow defines an originating entity and a recipient entity for each document in the set.

17. The system of claim 8, wherein each document in the workflow is associated with one or more related documents in the workflow.

18. The system of claim 8, wherein the workflow further defines a set of actionable functions permitted by a recipient entity of a document in the workflow.

19. The system of claim 8, wherein the workflow facilitates the delivery and exchange of the documents in the set based on definition for the workflow.

20. The system of claim 8, wherein the workflow further defines appropriate responsive action or related action, or both, for each event in the workflow, wherein one type of event is receipt of a document.

21. The system of claim 8, wherein the workflow includes a plurality of events, including comments, reviews, and approvals.

22. The system of claim 20, wherein the workflow further facilitates user function to act on the document to perform a related action or to trigger a related workflow.

23. The system of claim 8, wherein each document in the set for the workflow is associated with one or more attributes.

24. The system of claim 23, wherein a first attribute is indicative of a status of whether the document is routed within the originating entity or sent to the recipient entity.

25. The system of claim 8, wherein each of at least one document in the workflow is associated with one or more related documents, and wherein upon receipt of such a document a recipient entity is authorized to create the one or more related documents.

26. The system of claim 8, wherein each document schema identifies whether a new document is creatable from scratch based on the document schema or in response to a created document.

27. The system of claim 8, wherein a document schema is definable to include a combination of text, graphics, and color.

28. The system of claim 8, wherein a document schema is definable to include a hyperlink.

29. The system of claim 8, wherein a document schema is definable to include one or more fields mapped from or to another document schema.

30. The system of claim 8, wherein a document template is definable from a document schema.

31. The system of claim 8, wherein a document template is definable from a created document.

32. The system of claim 8, wherein a document template is definable to include default data in one or more fields.

33. The system of claim 8, wherein a document template is definable to support one or more actions.

34. The system of claim 33, wherein the one or more actions includes collaboration whereby a document is sent back to an originating entity without modification of the document.

35. The system of claim 33, wherein the one or more actions includes approval process.

36. The system of claim 8, wherein one or more fields in each of one or more documents in the set are selectively enabled or disabled based on a previous selection or information.

37. The system of claim 8, further comprising:
a sixth module operative to allow the user to define business logics for the workflow.

38. The system of claim 8, wherein the business logics includes validation rules to validate data in documents.

39. The system of claim 8, further comprising:
a module operative to provide tools for defining data inheritance between selected fields of multiple documents, wherein data entered for the selected fields in a first document is propagated to the corresponding selected fields in a second document.

40. The system of claim 8, further comprising:
a module operative to provide tools for defining data linking between selected fields of multiple documents, wherein data entered for the selected fields in a first document is associated with data in the corresponding selected fields in a second documents.

41. The system of claim 8, further comprising:
a module operative to provide tools for defining entities and groups of entities.

42. The system of claim 8, further comprising:
a module operative to provide tools for defining an access control list of entities granted access to each document in the set.

43. The system of claim 8, further comprising:
a module operative to provide tools for defining relationships of the entities in an access control list, wherein each relationship between a pair of entities includes a document exchange relationship and a resource sharing relationship.

44. The system of claim 8, further comprising:
a module operative to provide tools for defining a hierarchical structure for a particular entity to include one or more groups of user accounts.

45. The system of claim 8, wherein the system is accessible via the Internet.

46. The system of claim 8, further comprising:
a data storage unit operative to store the -defined documents and workflow and input data for the documents.

47. The system of claim 8, wherein the system is implemented within a unified platform.

48. A system for facilitating creation, exchange, and management of documents to support business transactions, comprising:
a first module operative to provide tools for defining document schemas, wherein each document schema includes a set of fields for structured or semi-structured information, and wherein documents representative of business transactions between entities are generated based on the document schemas;
a second module operative to provide tools for defining entities granted access to the system; and
a third module operative to provide tools for defining workflows, wherein each workflow is representative of a business process and defines exchanges of a set of one or more documents among a plurality of entities, wherein the documents for each workflow are generated based on the defined document schemas and the entities for each workflow are selected from among the defined entities.

49. A computer program product operative to facilitate creation, exchange, and management of documents to support business transactions, comprising a computer-usable medium having embodied therein computer-readable program codes for
providing tools for defining document schemas, wherein each document schema includes a set of fields for structured or semi-structured information, and wherein documents representative of business transactions between entities are generated based on the document schemas;
providing tools for defining entities granted access to the system; and
providing tools for defining workflows, wherein each workflow is representative of a business process and defines exchanges of a set of one or more documents among a plurality of entities, wherein the documents for each workflow are generated based on the defined document schemas and the entities for each workflow are selected from among the defined entities.

50. A system for facilitating management of multiple versions of document schemas and layouts for documents used to represent business transactions, comprising:
a first module operative to provide tools to generate a new version of the document schema or layout from an existing document schema or layout or from scratch;
a second module operative to maintain multiple versions of document schemas and layouts;
a third module operative to receive a selection for creation of a new document based on a particular document schema; and
a fourth module operative to direct creation of the new document based on a latest version of the particular document schema available on the system, and
wherein each created document includes an attribute indicative of a particular version of the associated document schema, and wherein each created document retains the particular document schema version even as new versions are created.

51. A system for facilitating creation, exchange, presentation, and management of documents to support business transactions, comprising:
a first module operative to provide a plurality of documents to an entity authorized to receive the documents;
a second module operative to receive a selection for a specific one of the plurality of documents, wherein the selected document is associated with a particular stage of a workflow representative of a particular business process; and
a third module operative to dynamically update a user interface for the entity based on the selected document and the particular stage in the workflow to which the selected document is associated, wherein the updated user interface includes documents defined to be related to the selected document.

52. The system of claim 51, wherein the dynamically updated user interface facilitates the presentation of the document and the functions available to the entity at the particular stage in the workflow.

53. The system of claim 51, wherein the dynamically updated user interface includes one or more buttons and one or more links defined to be associated with the interactions.

54. The system of claim 51, further comprising:
a fourth module operative to provide a plurality of documents to an entity registered and authorized to receive the documents.

55. A system for facilitating creation, exchange, presentation, and management of documents to support business transactions, comprising:
a first module operative to provide an application to each of a plurality of entities registered with the system, wherein each application includes user interface elements that allow the associated entity to perform functions to create, exchange, present, and manage documents;
a second module operative to receive data and associated instructions from entities for actions with respect to documents;
a third module operative to generate, modify, delete documents based on the received data and instructions;
a fourth module operative to send documents to recipient entities identified in the documents or by workflows to which the documents belong; and
a fifth module operative to enable documents to be selected for retrieval by entities, and
wherein each application dynamically updates user interfaces for the associated entities based on documents selected for retrieval and the particular stages in the workflows to which the documents belong or results of actions performed by the system.

56. The system of claim 55, wherein the updated user interface includes documents defined to be related to the selected document.

57. The system of claim 55, wherein the fourth module is operative to send selected ones of the documents via electronic data interchange (EDI)
